(19) United States
(12) Patent Application Publication
(10) Pub. No.: US 2024/0424603 A1
(43) Pub. Date: Dec. 26, 2024

(54) LASER BEAM MEASUREMENT DEVICE AND OUTPUT DATA CORRECTION METHOD

(71) Applicant: Tamron Co., Ltd., Saitama (JP)

(72) Inventor: Kazunori KOMORI, Saitama (JP)

(73) Assignee: Tamron Co., Ltd., Saitama (JP)

(21) Appl. No.: 18/652,272

(22) Filed: May 1, 2024

(30) Foreign Application Priority Data
Jun. 20, 2023 (JP) 2023-100708

(51) Int. Cl. B23K 26/073; B23K 26/03; B23K 26/06; B23K 26/067

(52) U.S. Cl. CPC B23K 26/073; B23K 26/032; B23K 26/0648; B23K 26/067

(57) ABSTRACT

A laser beam measurement device includes a plate-type first beam splitter, an observation device that reads an image of a spot formed by transmitted light or reflected light of a laser beam incident on the first beam splitter, and a calculation device that performs a numerical calculation on output data of the observation device to perform a correction, in which when certain coordinate axes orthogonal to each other on a plane perpendicular to an optical axis of a laser beam irradiation optical unit with origins of the orthogonal coordinate axes being located on the optical axis are defined as X and Y axes, the first beam splitter is disposed to be inclined at an angle α in a range of 30 degrees or more and 60 degrees or less with respect to the plane perpendicular to the optical axis with the X axis as a rotation axis.

### CROSS-REFERENCE TO RELATED APPLICATIONS

This application is based on and claims the benefit of priority from Japanese Patent Application No. 2023-100708, filed on Jun. 20, 2023, the entire contents of which are incorporated herein by reference.

### BACKGROUND OF THE INVENTION

### Technical Field

The present invention relates to a laser beam measurement device for a laser beam emitted from a laser beam irradiation optical unit that forms a spot on an object to be processed while emitting the laser beam for laser processing, and an output data correction method in the laser beam measurement device.

### Related Art

In recent years, laser beams have been widely used for processing various products. The laser beam is focused at one point when emitting to a workpiece, thereby rapidly increasing a surface temperature of the workpiece and melting or evaporating an irradiated surface of the workpiece. A laser processing device using such a laser beam is a device that performs processing such as cutting, drilling, or welding on the workpiece by doing so. Since the laser beam is focused at one point, precise and fine processing can be performed at a pinpoint. In addition, by using a higher-energy laser beam, a machining time can be shortened, and it is also possible to process a high-hardness workpiece that is difficult to process with a blade.

Here, the laser processing device includes a laser beam irradiation optical unit. A conventionally employed laser beam irradiation optical unit has a function of focusing a laser beam at one point of a spot, or irradiating the spot with a laser beam having a circular image shape and a Gaussian or top-hat energy intensity distribution. However, in laser processing employing such a conventional image shape of a spot, there has been a problem that a workpiece melted by a laser beam remains on a cut surface or a hole portion at the time of cutting, welding, or drilling the workpiece, causing a deterioration in processing quality. Therefore, in recent years, it has been proposed that laser processing is performed in such a manner that an image shape of a laser beam formed at a spot is annular so that a molten workpiece is appropriately ejected and does not remain on a cut surface or in a hole portion.

As described above, laser processing is performed in such a manner that an image shape of a laser beam at a spot and an energy intensity distribution in the image shape are changed from a circular Gaussian shape to an annular image shape or the like according to a condition for processing such as welding and cutting of a workpiece. At this time, before laser processing is performed, a laser beam measurement device is used to confirm whether an image shape of a laser beam at a spot and an energy intensity distribution in the image shape have desired specifications. As a laser beam attenuating means in this laser beam measurement device, the following method has been known: a method in which a laser beam is attenuated through a filter, and observed by an image sensor such as a CCD or CMOS; a method in which a transmitted light intensity is measured while a partial portion of the laser beam is shielded with a pinhole, a slit, or a knife edge, and obtained by a calculation from a correlation of the transmitted light intensity with a light shielding position; a method in which an intensity distribution is measured by secondarily scanning a rod with a small mirror at a tip or a light guide rod with a small hole at a tip in a laser beam; a method in which a laser beam is emitted to a plate for scattering the laser beam, and an image of scattered light is captured by a camera from behind; or the like.

However, in the above-described method, there is problem that the filter is deformed by heat of the laser beam, an image shape of the laser beam is impaired in the pinhole, the slit, or the knife edge, it is difficult to measure a minute image shape with the small mirror, or blurring occurs in the image when the scattered light is used. Therefore, WO 2019/021435 A1 discloses a method in which a laser beam is emitted to a fluorescent plate and an intensity distribution of fluorescence emitted from the fluorescent plate is measured using a camera or an image sensor.

Such a method, in which a laser beam is emitted to a fluorescent plate and an intensity distribution of fluorescence emitted from the fluorescent plate is measured using a camera or an image sensor, is as follows. The fluorescent plate electronically excites molecules of the fluorescent plate by absorbing photons of the incident laser beam, and emits low-energy photons corresponding to longer wavelengths than the absorbed photons when the excited molecules return to the ground state. These long-wavelength photons are fluorescence corresponding to the incident laser beam, and the energy of the fluorescence is lower than the energy of the incident laser beam. Here, since the wavelength of the laser beam and the wavelength of the fluorescence are different, the laser beam and the fluorescence are separated using a light separation element (prism or mirror) that separates lights having different wavelengths. Then, an energy intensity distribution of the laser beam is confirmed by measuring an intensity distribution of the fluorescence.

However, in the method using the fluorescent plate, a fluorescent image is blurred unless the fluorescent plate is thin. Therefore, in WO 2019/021435 A1, the thickness of the fluorescent plate is set to 0.2 mm. In the method using the fluorescent plate, it is necessary to make the fluorescent plate thin as described above, but the small thickness causes a problem that, when the energy intensity of the incident laser beam is as high as, for example, 100 W or more, an image shape and an intensity distribution of the laser beam cannot be correctly measured because the fluorescent plate is damaged by heat or the energy intensity of fluorescence is saturated.

Therefore, it may be considered to use a beam splitter on which a laser beam having a high energy intensity can be incident to split the laser beam into transmitted light and reflected light, so that an image shape and an intensity distribution of the laser beam are measured using the transmitted light or the reflected light having a lower energy intensity than the laser beam. For example, in a case where a plate-type beam splitter is used, a surface of the beam splitter is disposed to be inclined at a predetermined angle with respect to an optical axis. Then, a laser beam incident on the beam splitter is not collimated light but condensed light condensed at a spot. In this case, an incident angle of a laser beam at a different incident position on the beam splitter has a different value. Here, in general, a laser beam transmittance or reflectance of the beam splitter varies depending on an incident angle of a laser beam on the beam splitter. Therefore, since the transmittance or the reflectance varies depending on an incident position on the beam splitter, there is a problem that an energy intensity distribution cannot be correctly measured even though the measurement is performed using light transmitted through or reflected by the beam splitter. In addition, in a case where focused light is incident on the beam splitter, in addition to the shift of the orbit, astigmatism occurs in the transmitted light so that the emitted light is focused at different focal lengths. That is, there is also a problem that an image of the transmitted light is distorted due to the astigmatism, and an image shape of the laser beam at the spot cannot be correctly measured.

The present invention has been made in view of such circumstances. An object of the present invention is to provide a laser beam measurement device and an output data correction method capable of accurately measuring an image shape and an energy intensity distribution of a laser beam incident at a spot, by attenuating the laser beam using a beam splitter to such an extent that a device for acquiring image data such as an image sensor or a camera is not destroyed, even if the energy intensity of the laser beam is high.

### SUMMARY OF THE INVENTION

In order to solve the above-described problems, as a result of intensive research, a laser beam measurement device and an output data correction method to be described below have been conceived.

A laser beam measurement device employed according to the present invention is a laser beam measurement device for a laser beam emitted from a laser beam irradiation optical unit configured to form a spot while emitting the laser beam to an object to be processed for laser processing, the laser beam measurement device including: a plate-type first beam splitter; an observation device configured to read an image of the spot formed by transmitted light or reflected light of the laser beam incident on the first beam splitter; and a calculation device configured to perform a numerical calculation on output data of the observation device to perform a correction, in which when certain coordinate axes orthogonal to each other on a plane perpendicular to an optical axis of the laser beam irradiation optical unit with origins of the orthogonal coordinate axes being located on the optical axis are defined as X and Y axes, the first beam splitter is disposed to be inclined at an angle α in a range of 30 degrees or more and 60 degrees or less with respect to the plane perpendicular to the optical axis with the X axis as a rotation axis.

A laser beam measurement device according to the present invention preferably includes a plate-type second beam splitter in the above-described laser beam measurement device, in which the second beam splitter is disposed to be inclined at an angle −α with respect to the plane perpendicular to the optical axis with an X′ axis as a rotation axis, the X′ axis being parallel to the X axis and passing through the optical axis, and the spot is formed by transmitted light of the laser beam incident on the first beam splitter and the second beam splitter.

An output data correction method employed according to the present invention is an output data correction method of the calculation device in the above-described laser beam measurement device, the calculation device performing a correction by performing a numerical calculation on output data of the observation device that reads an image of a spot formed by transmitted light of a laser beam incident on the first beam splitter, the output data correction method including: performing a numerical calculation for correcting an energy intensity in the output data in a Y-axis direction of the output data based on a transmittance value of the first beam splitter corresponding to an incident angle of the laser beam on the first beam splitter; and performing a numerical calculation for correcting a coordinate position in the output data by correcting the coordinate position in a Y-axis direction of the output data based on a ratio value between a largest value of a size of the image in an X-axis direction and a largest value of a size of the image in the Y-axis direction in an image shape on the observation device.

An output data correction method employed according to the present invention is an output data correction method of the calculation device in the above-described laser beam measurement device, the calculation device performing a correction by performing a numerical calculation on output data of the observation device that reads an image of a spot formed by reflected light of a laser beam incident on the first beam splitter, the output data correction method including: performing a numerical calculation for correcting an energy intensity in the output data in a Y-axis direction of the output data based on a reflectance value of the first beam splitter corresponding to an incident angle of the laser beam on the first beam splitter.

An output data correction method employed according to the present invention is an output data correction method of the calculation device in the above-described laser beam measurement device including the second beam splitter, the calculation device performing a correction by performing a numerical calculation on output data of the observation device that reads an image of a spot formed by transmitted light of a laser beam incident on the first beam splitter and the second beam splitter, the output data correction method including: performing a numerical calculation for correcting a coordinate position in the output data by correcting the coordinate position in a Y-axis direction of the output data based on a ratio value between a largest value of a size of the image in an X-axis direction and a largest value of a size of the image in the Y-axis direction in an image shape on the observation device.

The laser beam measurement device according to the present invention is capable of measuring an image shape and an energy intensity distribution of a laser beam incident at a spot, by attenuating the laser beam to such an extent that a device for acquiring image data such as an image sensor or a camera is not destroyed, even if the energy intensity of the laser beam is high. The output data correction method according to the present invention is capable of correcting an image shape of the output data to an appropriate image shape. The laser beam measurement device according to the present invention is capable of accurately measuring an image shape and an energy intensity distribution of a laser beam at a spot even if the energy intensity of the laser beam is high.

### BRIEF DESCRIPTION OF THE DRAWINGS

FIG. 1 is a schematic view of a laser beam measurement device according to a first embodiment;

FIG. 2 is an example of a transmittance characteristic with respect to an incident angle on a first beam splitter;

FIG. 3 is an enlarged view of a portion where the first beam splitter is located;

FIG. 4 is a schematic view of a laser beam measurement device according to a second embodiment;

FIG. 5 is an example of a reflectance characteristic with respect to an incident angle on a first beam splitter;

FIG. 6 is an enlarged view of a portion where the first beam splitter is located;

FIG. 7 is a schematic view of a laser beam measurement device according to a third embodiment;

FIG. 8 is an enlarged view of a portion where a first beam splitter and a second beam splitter are located;

FIGS. 9A and 9B are results of measuring an energy intensity distribution of an image at a spot in Example 1;

FIG. 10 is a result of an image shape at the spot in Example 1;

FIGS. 11A and 11B are results of measuring an energy intensity distribution of an image at a spot in Example 2;

FIG. 12 is a result of an image shape at the spot in Example 2;

FIGS. 13A and 13B are results of measuring an energy intensity distribution of an image at a spot in Example 3;

FIG. 14 is a result of an image shape at the spot in Example 3;

FIGS. 15A and 15B are results of measuring an energy intensity distribution of an image at a spot in Comparative Example 1;

FIG. 16 is a result of an image shape at the spot in Comparative Example 1;

FIGS. 17A and 17B are results of measuring an energy intensity distribution of an image at a spot in Comparative Example 2;

FIG. 18 is a result of an image shape at the spot in Comparative Example 2;

FIGS. 19A and 19B are results of measuring an energy intensity distribution of an image at a spot in Comparative Example 3; and

FIG. 20 is a result of an image shape at the spot in Comparative Example 3.

### DESCRIPTION OF THE EMBODIMENTS

Hereinafter, a laser beam measurement device and an output data correction method according to embodiments of the present invention will be described. Note that what will be described below merely shows one aspect, and the present invention is not construed as being limited to the following description.

### 1. Embodiment of Laser Beam Measurement Device

A laser beam measurement device according to the present invention measures an image shape and an energy intensity distribution of a laser beam at a spot, by attenuating the laser beam emitted from a laser beam irradiation optical unit that forms a spot while emitting the laser beam to an object to be processed for laser processing to such an extent as not to destroy a device that acquires image data, such as an image sensor or a camera.

The laser beam irradiation optical unit is an optical system necessary for laser processing, and is an optical system that emits a laser beam to be focused on the spot while forming an image shape of the laser beam and an energy intensity distribution of the laser beam as desired at the spot. Here, the laser beam measurement device according to the present invention is attached between the laser beam irradiation optical unit and the spot to measure an image shape of the laser beam and an energy intensity distribution of the laser beam at the spot. Then, after the image shape of the laser beam and the energy intensity distribution of the laser beam are measured at the spot, the image shape of the laser beam and the energy intensity distribution of the laser beam at the spot can be adjusted and measured again if necessary, and then the laser beam measurement device can be detached from the laser beam irradiation optical unit. Thereafter, an object to be processed can be installed at the position of the spot to perform laser processing. In addition, a laser beam can be branched in the laser beam irradiation optical unit, and the laser beam measurement device can also be used to observe an image shape and an energy intensity distribution of the laser beam during laser processing.

Note that the laser beam irradiation optical unit according to the present invention may include any optical system as long as laser processing can be performed. For example, the laser beam irradiation optical unit may include a galvano optical system including a galvano mirror.

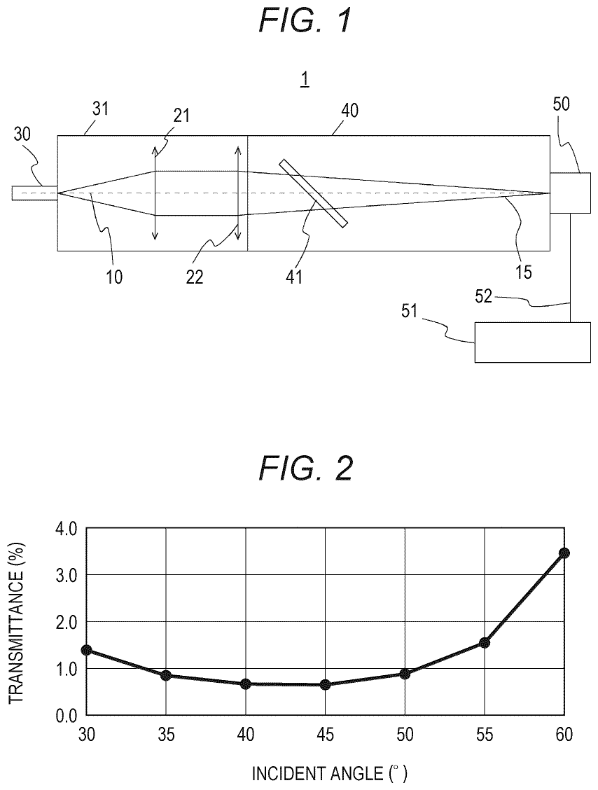

FIG. 1 illustrates an arrangement configuration of a laser beam measurement device and a substantial irradiation orbit of a laser beam according to a first embodiment of the present invention. In the laser beam measurement device according to the first embodiment, the following components are arranged in order from a laser oscillator side along an optical axis 10 of an irradiation orbit of a laser beam irradiation optical unit 31: an optical fiber 30 that guides and emits a laser beam output from a laser oscillator (not illustrated); a collimator lens 21 that collimates the laser beam output in a diffused manner from an output end of the optical fiber 30; a condenser lens 22 that focuses the laser beam collimated by the collimator lens 21 at a spot on a surface of an object to be processed; an attenuation mechanism 40 that attenuates the laser beam focused by the condenser lens 22; and an observation device 50 that observes observation light for checking an image shape and an intensity distribution of the laser beam at the spot. The position of the optical center of the collimator lens 21 and the position of the optical center of the condenser lens 22 are disposed to coincide with the optical axis 10 in the laser beam irradiation optical unit 31. By configuring the laser beam measurement device according to the first embodiment as described above, the laser beam converges on the spot along an orbit indicated by the irradiation orbit 15 to form an image. Then, a calculation device 51 is connected to the observation device 50 via a connection cable 52. The laser beam measurement device according to the present invention includes the attenuation mechanism 40, the observation device 50, and the calculation device 51 described above.

As a laser beam incident on the laser beam irradiation optical unit 31 from the laser oscillator via the optical fiber 30, any laser beam can be used as long as the laser beam can be used for laser processing. In particular, a near-infrared laser beam having an oscillation wavelength of about 920 to 1080 nm, which is represented by a YAG laser (wavelength of 1064 nm), a fiber laser (wavelength of 1070 nm), a disk laser (wavelength of 1030 nm), and a semiconductor laser (wavelength of 935 nm, 940 nm, 980 nm, 940 to 980 nm, or 940 to 1025 nm), is preferable. The laser beam may be a laser beam in a blue, green, or ultraviolet region as long as the laser beam can be used for laser processing. In addition, the energy intensity distribution of the laser beam incident on the laser beam irradiation optical unit 31 on a plane perpendicular to the optical axis 10 may be strong in a center portion (optical axis portion) in a Gaussian shape or may be uniform.

In FIG. 1, the collimator lens 21 and the condenser lens 22 are installed in the laser beam irradiation optical unit 31 in such a manner that their respective optical centers coincide with the optical axis 10. That is, an optical system necessary for laser processing is disposed in the laser beam irradiation optical unit 31. The attenuation mechanism 40 is connected to the laser beam irradiation optical unit 31, and the observation device 50 is connected to the attenuation mechanism 40. At this time, the attenuation mechanism 40 may be covered with a lens barrel or the like so that a laser beam does not leak from the attenuation mechanism 40. Furthermore, the attenuation mechanism 40 may be detachable from the laser beam irradiation optical unit 31. By connecting the detachable attenuation mechanism 40, to which the observation device 50 can be connected, to the laser beam irradiation optical unit 31 constituting the optical axis 10 of the laser beam irradiation orbit 15, an image shape of the laser beam and an energy intensity distribution of the laser beam can be measured at the spot. Then, after a measurement is performed by the observation device 50 and the image shape and the intensity distribution of the laser beam at the spot are adjusted to be desirable, the attenuation mechanism 40 and the observation device 50 are removed, and a surface of an object to be processed is located at the position where an imaging surface of the observation device 50 was located, so that laser processing can be performed with high accuracy.

Here, the image shape of the laser beam at the spot may be any image shape as long as the object to be processed can be processed with the laser beam. For example, at least one of the collimator lens 21 and the condenser lens 22 of the laser beam irradiation optical unit 31 can have a function of converting the image shape of the laser beam at the spot into an annular shape including at least an annular peripheral region (hereinafter referred to as an annular shape conversion function in the present specification). When the shape of the energy intensity distribution at the spot becomes an annular shape including at least an annular peripheral region, the laser beam is irradiated with uniform energy in any direction with respect to the center region of the spot on the surface of the object to be processed. This allows zinc gas to be released during lap welding of molten zinc steel sheets, resulting in clean welding.

Furthermore, the shape of the spot based on the annular shape conversion function is not particularly limited, and the shape of the spot may include, for example, an annular shape and a point shape at a center portion of the annular shape (a Gaussian shape in the point portion), or may be a top-hat shape or the like. At this time, it is preferable that the energy intensity of the point-like spot in the center portion of the annular shape is higher than the energy intensity of the annular portion of the annular shape. This is because, in aluminum or the like having a high light reflectance, the metal can be melted at the annular portion having a low energy intensity to lower the reflectance, and an object to be processed can be melted deeply at the central portion having a high energy intensity, making laser processing easier.

In order to form the image shape of the spot described above, it is preferable that at least one optically effective surface of an optical element having an annular shape conversion function is a diffractive lens, an axicon lens, or an aspherical lens. This is because the spot shape of the laser beam can be an annular shape, or can include an annular shape and a point shape in the center portion of the annular shape.

Note that the laser beam irradiation optical unit 31 does not necessarily have an annular shape conversion function, and a laser beam emitted from the optical fiber 30 in such a manner that an image shape of the laser beam is an annular shape including at least an annular peripheral region may be used.

In addition, the laser beam irradiation optical unit 31 may include a laser beam direction adjustment mechanism including a connector part to which the optical fiber 30 is connected and a connector receiving part that fixes the connector part to the optical axis 10 of the irradiation orbit. The laser beam direction adjustment mechanism adjusts the incident direction of the laser beam on the irradiation orbit by turning at least one of the connector part and the connector receiving part in an arc shape with a center portion of a core of the optical fiber 30 at the laser beam output end as a center point. The laser beam output from the laser oscillator is guided to a laser processing head of a laser processing device using the optical fiber 30, and the emission direction of the laser beam output from the output end of the optical fiber 30 has an inclination in a certain range with respect to the optical axis 10. Specifically, for example, in a CW fiber laser manufactured by Raikus Fiber, an angle of an optical axis of a laser beam output from an output end of an optical fiber with respect to a reference optical axis determined by a structure of the output end of the optical fiber and a structure of a connector is 30 mrad (milliradian) or less. The laser beam direction adjustment mechanism can be used to adjust the incident direction of the laser beam on the irradiation orbit in a case where the emission direction of the laser beam output from the output end of the optical fiber 30 has an inclination in a certain range with respect to the optical axis 10.

Note that the laser beam irradiation optical unit 31 has a configuration in which the collimator lens 21 and the condenser lens 22 are arranged therein, but may have any configuration as long as laser processing can be performed, and for example, only the condenser lens 22 may be arranged therein.

### First Embodiment of Laser Beam Measurement Device

As illustrated in FIG. 1, a laser beam measurement device according to a first embodiment of the present invention includes an attenuation mechanism 40 including a plate-type first beam splitter 41 closer to the spot (the observation device 50) than the laser beam irradiation optical unit 31, an observation device 50 that reads an image of the spot formed by transmitted light of a laser beam incident on the first beam splitter 41, and a calculation device 51 that performs a numerical calculation on output data of the observation device 50 to perform a correction. Then, the observation device 50 and the calculation device 51 are connected to each other via the connection cable 52. The laser beam measurement device according to the present invention includes the attenuation mechanism 40, the observation device 50, and the calculation device 51 described above. The first beam splitter 41 may be disposed in such a manner that the center position of the first beam splitter 41 coincides with the optical axis 10, but may be disposed in such a manner that at least the laser beam irradiation orbit 15 is within the optically effective surface of the first beam splitter 41. When certain coordinate axes orthogonal to each other on the plane perpendicular to the optical axis 10 with their origins being located on the optical axis 10 are defined as X and Y axes, the first beam splitter 41 is disposed to be inclined at an angle α in a range of 30 degrees or more and 60 degrees or less with respect to the plane perpendicular to the optical axis 10 with the X axis as a rotation axis. Note that the plane perpendicular to the optical axis 10 in FIG. 1 is a plane perpendicular to the optical axis 10 including only one point on the optical axis 10, the X axis is a straight line on the plane perpendicular to the optical axis 10, perpendicularly penetrating the view of FIG. 1 when taken as a plane with the optical axis 10 as an origin, and the Y axis is a straight line on the plane perpendicular to the optical axis 10, being orthogonal to the X axis on the view of FIG. 1 when taken as a plane with the optical axis 10 as an origin. In the present invention, the X axis and the Y axis are defined in the same manner as described above in the other drawings.

The first beam splitter 41 has a function of splitting an incident laser beam into transmitted light and reflected light. In FIG. 1, the laser beam irradiation orbit 15 includes an orbit of a laser beam incident on the first beam splitter 41 and an orbit of light transmitted through the first beam splitter 41, and light reflected from the first beam splitter 41 is not illustrated. That is, in the first embodiment, the observation device 50 observes light transmitted through the first beam splitter 41. At this time, when the incident angle of the laser beam on the first beam splitter 41 is 45 degrees with respect to the optical surface of the first beam splitter 41, it is preferable that the laser beam transmittance of the first beam splitter 41 is 0.1% or more and 5.0% or less. This is because, with respect to an incident laser beam, an energy intensity of a transmitted light component of the laser beam decreases. Unnecessary reflected light reflected by the first beam splitter 41 may be emitted to a copper plate or the like processed to have a black surface so as to easily absorb the laser beam for absorptive radiation.

Note that the thickness of the first beam splitter 41 is not particularly limited as long as it can be used for the attenuation mechanism 40.

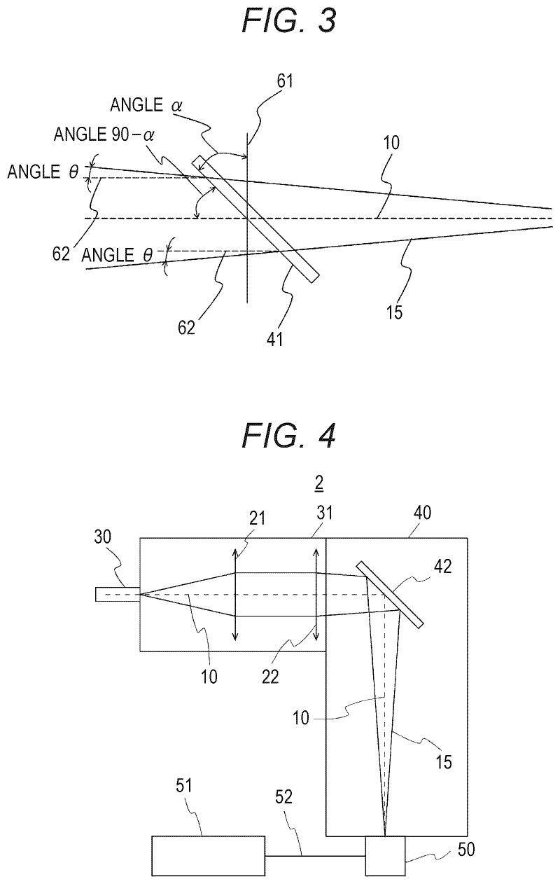

In addition, in the plate-type beam splitter, transmitted light is shifted with respect to the optical axis 10 by refraction (a shift of transmitted light is not illustrated in FIGS. 1 and 3). However, since the attenuation mechanism 40 is for measuring an energy intensity distribution and an image shape of the laser beam using the observation device 50, the shift of the transmitted light with respect to the optical axis 10 does not cause a problem.

The beam splitter is usually designed in such a manner that a predetermined transmittance or reflectance is obtained with an incident angle on the beam splitter with respect to an optical surface of the beam splitter being 45 degrees. When the incident angle of the laser beam on the beam splitter continuously changes from 45 degrees to different values, the transmittance value of the beam splitter continuously changes to different values. FIG. 2 illustrates an example of a design for a transmittance with respect to an incident angle on the beam splitter in which the dependency of the transmittance on the incident angle is reduced using 19-layer optical thin film. The horizontal axis represents an incident angle) (° of a laser beam on the beam splitter, and the vertical axis represents a laser beam transmittance (%). Here, a transmittance at an incident angle of 40° is 0.75%, and a transmittance at an incident angle of 50° is 0.92%. In FIG. 1, as indicated by the irradiation orbit 15, since a laser beam is incident on the first beam splitter 41 via the condenser lens 22, the incident angle of the laser beam on the first beam splitter 41 continuously changes in the Y-axis direction described above. In a case where the transmittance characteristic of the first beam splitter 41 is a characteristic illustrated in FIG. 2, if the minimum incident angle on the first beam splitter 41 is 40° and the maximum incident angle on the first beam splitter 41 is 50°, the transmittance ratio of transmitted light at the maximum incident angle to transmitted light at the minimum incident angle is 0.92/0.75=1.2 times. In this case, the energy intensity distribution of the laser beam at the spot cannot be correctly measured.

An enlarged view of a portion where the first beam splitter 41 is located is illustrated in FIG. 3. In FIG. 3, the laser beam irradiation orbit 15 includes an orbit of a laser beam incident on the first beam splitter 41 and an orbit of light transmitted through the first beam splitter 41, and light reflected from the first beam splitter 41 is not illustrated. Here, the first beam splitter 41 is disposed to be inclined at an angle α with respect to a plane 61 perpendicular to the optical axis 10 in the above-described range with the X axis as a rotation axis. As illustrated in FIG. 3, a value of an incident angle of the laser beam on the first beam splitter 41 with respect to the optical surface of the first beam splitter 41 at the position of the optical axis 10 is (90−α) expressed as an angle smaller than 90 degrees. For example, an incident angle of the laser beam at the position of the upper end of the irradiation orbit 15 on the first beam splitter 41 with respect to the optical surface of the first beam splitter 41 is expressed by (90−α)−θ, with the value of the incident angle at the position of the optical axis 10 as a reference. In addition, an incident angle of the laser beam at the position of the lower end of the irradiation orbit 15 on the first beam splitter 41 with respect to the optical surface of the first beam splitter 41 is expressed by (90−α)+θ, with the value of the incident angle at the position of the optical axis 10 as a reference. Here, the angle θ is an incident angle of the laser beam at the position of the upper or lower end of the irradiation orbit 15 with respect to a virtual line 62 parallel to the optical axis 10, that is, an angle of a difference from the incident angle at the position of the optical axis 10. That is, the value of the incident angle of the laser beam on the first beam splitter 41 with respect to the optical surface of the first beam splitter 41 continuously changes in a range from (90−α)−θ to (90−α)+θ.

Since the value of the incident angle of the laser beam on the first beam splitter 41 with respect to the optical surface of the first beam splitter 41 continuously changes as described above, the value of the transmittance of the first beam splitter 41 continuously changes according to the incident position. Therefore, the energy intensity distribution of the transmitted light of the laser beam transmitted through the first beam splitter 41 changes in the Y-axis direction according to the change in transmittance with respect to the energy intensity distribution of the incident light. That is, the energy intensity distribution of the laser beam measured by the observation device 50 is biased in the Y-axis direction with respect to the energy intensity distribution of the laser beam incident on the attenuation mechanism 40.

The measured energy intensity distribution of the output data of the laser beam biased in the Y-axis direction can be corrected by a numerical calculation using the calculation device 51. Hereinafter, an output data correction method for correction to an energy intensity distribution similar to the energy intensity distribution of the laser beam incident on the first beam splitter 41 by performing a numerical calculation for correcting the energy intensity distribution of the output data in the Y-axis direction will be described. However, the output data correction method is not limited to the following description as long as the energy intensity distribution position of the output data can be corrected in the Y-axis direction. First, data on the dependency of the transmittance of the first beam splitter 41 on the incident angle is acquired in advance. Furthermore, for example, at each data position on the imaging surface of the spot position observation device 50, data on the incident angle on the first beam splitter 41 is acquired in advance by tracing an optical path of the light beam toward an emission point of the laser beam from the optical fiber 30 using a ray tracing method. The data acquired in advance is stored in a storage device of the calculation device 51. Then, based on the data on the incident angle on the first beam splitter 41 at each data position on the imaging surface of the observation device 50 acquired in advance, the incident angle on the first beam splitter 41 is found from the data position on the imaging surface of the observation device 50 in the output data of the observation device 50 according to the incidence of the laser beam. Furthermore, based on the data on the dependency of the transmittance of the first beam splitter 41 on the incident angle acquired in advance, with the transmittance at the incident angle on the first beam splitter 41 at the position of the optical axis 10 as a reference in the output data of the observation device 50, an energy intensity value at another position is corrected.

More specifically, for example, the present invention can be carried out as follows. A coordinate value on the X axis and a coordinate value on the Y axis of data output from the observation device 50 at a certain position are defined as x and y, respectively. Then, when a transmittance at the incident angle on the first beam splitter 41 at the position of the optical axis 10 is defined as a, a transmittance at the incident angle on the first beam splitter 41 of a laser beam reaching the certain coordinate position (x, y) on the imaging surface of the observation device 50 is defined as b, and an energy intensity value at the certain coordinate position (x, y) in the output data of the observation device 50 is defined as E, a corrected energy intensity value E′ at the certain coordinate position (x, y) of the observation device 50 can be E′=(a/b)·E. That is, the energy intensity in the output data can be corrected in the Y-axis direction of the output data, based on the transmittance value of the first beam splitter 41 corresponding to the incident angle of the laser beam on the first beam splitter 41. In this manner, the energy intensity distribution of the laser beam measured by the observation device 50, which is a distribution biased in the Y-axis direction, can be corrected to an energy intensity distribution similar to the energy intensity distribution of the laser beam incident on the first beam splitter 41 using the calculation device 51. Therefore, it is preferable that the calculation device 51 has a numerical calculation function capable of performing the above-described calculation.

Note that, since the first beam splitter 41 is disposed to be inclined at the angle α with the X axis as a rotation axis, the incident angle of the laser beam on the optical surface of the first beam splitter 41 does not change in the X-axis direction. Therefore, the energy intensity distribution of the laser beam measured by the observation device 50 is not biased in the X-axis direction with respect to the energy intensity distribution of the laser beam incident on the attenuation mechanism 40.

Next, as illustrated in FIG. 3, the first beam splitter 41 is disposed to be inclined at an angle α in a range of 30 degrees or more and 60 degrees or less with respect to a plane perpendicular to the optical axis 10 with the X axis as a rotation axis. When the plate-type beam splitter is disposed to be inclined with respect to the plane perpendicular to the optical axis in this manner, in a case where collimated light is incident on the beam splitter, the orbit of light emitted from the beam splitter is shifted with respect to the incident light due to refraction. In a case where focused light is incident on the beam splitter, in addition to the shift of the orbit, astigmatism occurs so that the emitted light is focused at the same focal length the X-axis direction, but the emitted light is focused at different focal lengths in the Y-axis direction. That is, an image of the laser beam transmitted through the first beam splitter 41 of which rotation axis is the X axis is distorted in the Y-axis direction due to astigmatism.

The measured image shape of the output data of the laser beam distorted in the Y-axis direction can be corrected by a numerical calculation using the calculation device 51. Hereinafter, an output data correction method for correction to an image shape similar to the image shape of the laser beam incident on the first beam splitter 41 by performing a numerical calculation for correcting the image shape of the output data in the Y-axis direction will be described. However, the output data correction method is not limited to the following description as long as the image shape can be corrected in the Y-axis direction of the output data.

A first method is an output data correction method that can be used in a case where an outer peripheral contour of an image shape of the laser beam incident on the attenuation mechanism 40 on a plane perpendicular to the optical axis 10 is a circle. In this case, since the outer peripheral contour of the image shape of the laser beam incident on the attenuation mechanism 40 on the plane perpendicular to the optical axis 10 is a circle, a ratio of the size in the X-axis direction to the size in the Y-axis direction in the outer peripheral contour of the image shape of the laser beam incident on the attenuation mechanism 40 is 1:1. At this time, since an image on the X axis of the image shape at the spot of the laser beam output from the attenuation mechanism 40 is not distorted, the Y-axis position of the output data can be corrected using a ratio of a diameter of an image on the Y axis with respect to a diameter of the image on the X axis.

For example, on the imaging surface of the observation device 50, a diameter value of an image in the X-axis direction is defined as c, a diameter value of an image in the Y-axis direction is defined as d, and a coordinate value on the X axis and a coordinate value on the Y axis of data output from the observation device 50 at a certain position is defined as x and y, respectively. At this time, a corrected data position of the certain position can be represented by x for a coordinate value on the X axis and (c/d)·y for a coordinate value on the Y axis. That is, by performing the numerical calculation for correcting the coordinate position of the output data from the observation device 50 in the Y-axis direction using the calculation device 51 as described above, corrected output data that is an image shape similar to the image shape of the laser beam incident on the first beam splitter 41 is obtained. By displaying the corrected output data on a display device, the output data can be observed as the image shape at the spot. Therefore, it is preferable that the calculation device 51 has a numerical calculation function capable of performing the above-described calculation.

A second method is an output data correction method that can be used in a case where outer peripheral contours of image shapes of laser beams incident on the attenuation mechanism 40 on a plane perpendicular to the optical axis 10 are a circle and shapes other than a circle. First, optical calculations are performed based on optical information about an optical system closer to the light source than the attenuation mechanism 40, that is, image shapes of laser beams of the light source and optical information about the collimator lens 21 and the condenser lens 22, to acquire data (primary data) on the image shapes of the laser beams at a plurality of spot positions (focal length positions) when the attenuation mechanism 40 is not included in advance, and the acquired data is stored in the storage device of the calculation device 51. Next, in an optical system including the attenuation mechanism 40, a laser beam is emitted, and data (secondary data) on an image shape of the laser beam is acquired from the observation device 50 at a certain position set as a spot position.

Data on an image shape at the same spot position (focal length position) as the secondary data is acquired is selected from the primary data. A largest value of the size of the image in the X-axis direction of the image shape is defined as e, and a value of the smallest size of the image in the Y-axis direction is defined as f. From the secondary data, a largest value of the size of the image in the X-axis direction of the image shape is defined as g, and a value of the smallest size of the image in the Y-axis direction is defined as h. At this time, when a coordinate value on the X axis and a coordinate value on the Y axis of the data output from the observation device 50 at the certain position are x and y, respectively, a corrected data position of the certain position can be represented by x for a coordinate value on the X axis and ((f·g)/(e·h))·y for a coordinate value on the Y axis. That is, by performing the numerical calculation for correcting the coordinate position of the output data from the observation device 50 in the Y-axis direction using the calculation device 51 as described above, corrected output data is obtained as an image shape similar to the image shape of the laser beam incident on the first beam splitter 41. By displaying the corrected output data on a display device, the output data can be observed as the image shape at the spot. Therefore, it is preferable that the calculation device 51 has a numerical calculation function capable of performing the above-described calculation.

Note that, in a case where the diameter value of the image on the X axis or the Y axis or the largest value of the size of the image in the X-axis direction or the Y-axis direction cannot be clearly determined in the above description, from data on a contour of an image with a predetermined intensity (e.g., 10%) when the largest value of the energy intensity of the laser beam measured by the observation device 50 is 100%, a diameter value of the image on the X axis or the Y axis or a largest value of the size of the image in the X-axis direction or the Y-axis direction may be determined.

That is, with respect to the Y-axis direction of the output data, by correcting the coordinate position of the output data in the Y-axis direction based on a value of a ratio between the largest value of the size of the image in the X-axis direction of the image shape and the largest value of the size of the image in the Y-axis direction for the image shape on the observation device 50, the coordinate position of the output data can be corrected in the Y-axis direction. By using the first method, the second method, or the like described above, the image shape of the laser beam at the spot distorted in the Y-axis direction measured by the observation device 50 can be corrected to a correct image shape (an image shape similar to the image shape of the laser beam incident on the attenuation mechanism 40) using the calculation device 51.

From the above, in the first embodiment of the laser beam measurement device, it is preferable that the calculation device 51 having a numerical calculation function with respect to output data from the observation device 50 is included to correct the energy intensity of the output data in the Y-axis direction and correct the coordinate position of the output data in the Y-axis direction.

Note that, in the configuration of the attenuation mechanism 40 illustrated in FIG. 1, in a case where light attenuation is insufficient for a laser beam to have an energy intensity so as to be incident on the observation device 50, an optical element such as an ND filter capable of attenuating the laser beam may be arranged between the first beam splitter 41 and the observation device 50.

As described above, the laser beam measurement device according to the first embodiment of the present invention includes an attenuation mechanism 40 including a first beam splitter 41 closer to the spot than the laser beam irradiation optical unit 31, an observation device 50 that measures information on an image of a laser beam formed at the position of the spot, and a calculation device 51 that performs a numerical calculation on output data of the observation device 50 to perform a correction. When certain coordinate axes orthogonal to each other on a plane perpendicular to the optical axis 10 with their origins being located on the optical axis 10 are defined as X and Y axes, the first beam splitter 41 is disposed to be inclined at an angle α in a range of 30 degrees or more and 60 degrees or less with respect to the plane perpendicular to the optical axis 10 with the X axis as a rotation axis. As a result, the power of the laser beam that can be incident is as large as 1 kW at normal times, and the laser beam can be output from the attenuation mechanism 40 after the energy intensity of the laser beam is reduced to such an extent that the observation device 50 that acquires image data from an image sensor, a camera, or the like is not destroyed. Then, with respect to the Y-axis direction of the output data from the observation device 50, using the calculation device 51 having a numerical calculation function, the energy intensity in the Y-axis direction of the output data can be corrected, and the coordinate position in the Y-axis direction of the output data can be corrected. By using the corrected output data, an energy intensity distribution at the spot can be measured to be similar to the energy intensity distribution of the laser beam incident on the attenuation mechanism 40, with an image shape similar to the image shape of the laser beam incident on the attenuation mechanism 40.

### Second Embodiment of Laser Beam Measurement Device

As illustrated in FIG. 4, a laser beam measurement device according to a second embodiment of the present invention includes an attenuation mechanism 40 including a plate-type first beam splitter 42 closer to the spot (the observation device 50) than the laser beam irradiation optical unit 31, an observation device 50 that reads an image of the spot formed by reflected light of a laser beam incident on the first beam splitter 42, and a calculation device 51 that performs a numerical calculation on output data of the observation device 50 to perform a correction. Then, the observation device 50 and the calculation device 51 are connected to each other via the connection cable 52. The laser beam measurement device according to the present invention includes the attenuation mechanism 40, the observation device 50, and the calculation device 51 described above. The first beam splitter 42 may be disposed in such a manner that the center position of the first beam splitter 42 coincides with the optical axis 10, but may be disposed in such a manner that at least the laser beam irradiation orbit 15 is within the optically effective surface of the first beam splitter 42. When certain coordinate axes orthogonal to each other on the plane perpendicular to the optical axis 10 with their origins being located on the optical axis 10 are defined as X and Y axes, the first beam splitter 42 is disposed to be inclined at an angle α in a range of 30 degrees or more and 60 degrees or less with respect to the plane perpendicular to the optical axis 10 with the X axis as a rotation axis. Note that the plane perpendicular to the optical axis 10 in FIG. 4 is a plane perpendicular to the optical axis 10 including only one point on the optical axis 10, the X axis is a straight line on the plane perpendicular to the optical axis 10, perpendicularly penetrating the view of FIG. 4 when taken as a plane with the optical axis 10 as an origin, and the Y axis is a straight line on the plane perpendicular to the optical axis 10, being orthogonal to the X axis on the view of FIG. 4 when taken as a plane with the optical axis 10 as an origin. In the present invention, the X axis and the Y axis are defined in the same manner as described above in the other drawings.

The first beam splitter 42 has a function of splitting an incident laser beam into transmitted light and reflected light. In FIG. 4, the laser beam irradiation orbit 15 includes an orbit of a laser beam incident on the first beam splitter 42 and an orbit of light reflected by the first beam splitter 42, and light transmitted through the first beam splitter 42 is not illustrated. That is, in the second embodiment, the observation device 50 observes light reflected by the first beam splitter 42. At this time, when the incident angle of the laser beam on the first beam splitter 42 is 45 degrees with respect to the optical surface of the first beam splitter 42, it is preferable that the laser beam reflectance of the first beam splitter 42 is 0.1% or more and 5.0% or less. This is because, with respect to an incident laser beam, an energy intensity of a reflected light component of the laser beam decreases. Unnecessary transmitted light transmitted through the first beam splitter 42 may emitted to a copper plate or the like processed to have a black surface so as to easily absorb the laser beam for absorptive radiation.

Note that the thickness of the first beam splitter 42 is not particularly limited as long as it can be used for the attenuation mechanism.

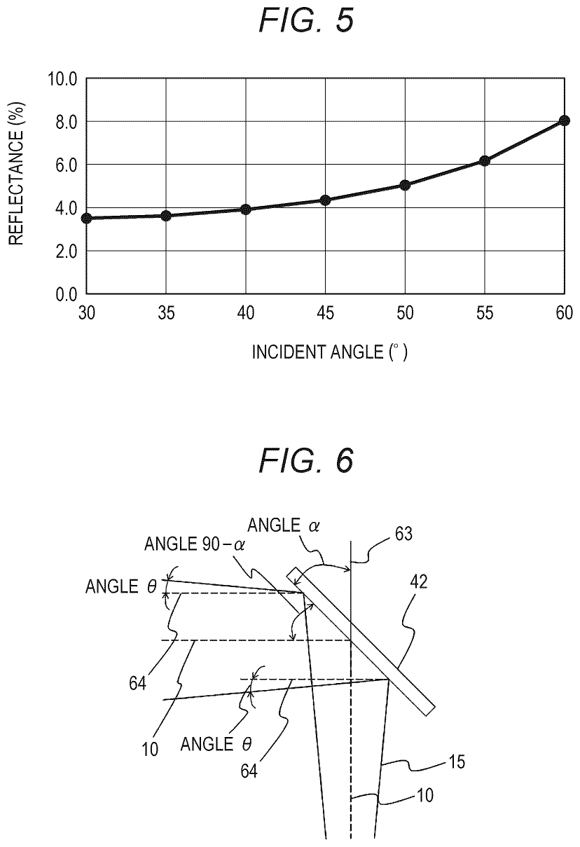

The beam splitter is usually designed in such a manner that a predetermined transmittance or reflectance is obtained with an incident angle on the beam splitter with respect to an optical surface of the beam splitter being 45 degrees. When the incident angle of the laser beam on the beam splitter continuously changes from 45 degrees to different values, the reflectance value of the beam splitter continuously changes to different values. In FIG. 4, as indicated by the irradiation orbit 15, since a laser beam is incident on the first beam splitter 42 via the condenser lens 22, the incident angle of the laser beam on the first beam splitter 42 continuously changes in the Y-axis direction described above. FIG. 5 illustrates an example of a design for a reflectance with respect to an incident angle of the beam splitter, the dependency of the reflectance on the incident angle being relatively large with no thin film formed on the surface of the plate. The horizontal axis represents an incident angle) (° of a laser beam on the beam splitter, and the vertical axis represents a laser beam reflectance (%). Here, a reflectance at an incident angle of 40° is 3.95%, and a reflectance at an incident angle of 50° is 5.00%. In a case where the reflectance characteristic of the first beam splitter 42 is a characteristic illustrated in FIG. 5, if the minimum incident angle on the first beam splitter 42 is 40° and the maximum incident angle on the first beam splitter 41 is 50°, the reflectance ratio of reflected light at the maximum incident angle to reflected light at the minimum incident angle is 5.00/3.95=1.27 times. In this case, the energy intensity distribution of the laser beam at the spot cannot be correctly measured.

This will be described with reference to FIG. 6, which is an enlarged view of a portion where the first beam splitter 42 is located. The first beam splitter 42 is disposed to be inclined at an angle α with respect to a plane 63 perpendicular to the optical axis 10 in the above-described range with the X axis as a rotation axis. As illustrated in FIG. 6, a value of an incident angle of the laser beam on the first beam splitter 42 with respect to the optical surface of the first beam splitter 42 at the position of the optical axis 10 is (90−α) expressed as an angle smaller than 90 degrees. For example, an incident angle of the laser beam at the position of the upper end of the irradiation orbit 15 on the first beam splitter 42 with respect to the optical surface of the first beam splitter 42 is expressed by (90−α)−θ, with the value of the incident angle at the position of the optical axis 10 as a reference. In addition, an incident angle of the laser beam at the position of the lower end of the irradiation orbit 15 on the first beam splitter 42 with respect to the optical surface of the first beam splitter 42 is expressed by (90−α)+θ, with the value of the incident angle at the position of the optical axis 10 as a reference. Here, the angle θ is an incident angle of the laser beam at the position of the upper or lower end of the irradiation orbit 15 with respect to a virtual line 64 parallel to the optical axis 10, that is, an angle of a difference from the incident angle at the position of the optical axis 10. That is, the value of the incident angle of the laser beam on the first beam splitter 42 with respect to the optical surface of the first beam splitter 42 continuously changes in a range from (90−α)−θ to (90−α)+θ.

Since the value of the incident angle of the laser beam on the first beam splitter 42 with respect to the optical surface of the first beam splitter 42 continuously changes as described above, the value of the reflectance of the first beam splitter 42 continuously changes according to the incident position. Therefore, the energy intensity distribution of the reflected light of the laser beam reflected by the first beam splitter 42 changes in the Y-axis direction according to the change in reflectance with respect to the energy intensity distribution of the incident light. That is, the energy intensity distribution of the laser beam measured by the observation device 50 is biased in the Y-axis direction with respect to the energy intensity distribution of the laser beam incident on the attenuation mechanism 40.

The measured energy intensity distribution of the output data of the laser beam biased in the Y-axis direction can be corrected by a numerical calculation using the calculation device 51 described above. Hereinafter, an output data correction method for correction to an energy intensity distribution similar to the energy intensity distribution of the laser beam incident on the first beam splitter 42 by performing a numerical calculation for correcting the energy intensity distribution of the output data in the Y-axis direction will be described. However, the output data correction method is not limited to the following description as long as the energy intensity distribution position of the output data can be corrected in the Y-axis direction. First, data on the dependency of the reflectance of the first beam splitter 42 on the incident angle is acquired in advance. Furthermore, for example, at each data position on the imaging surface of the spot position observation device 50, data on the incident angle on the first beam splitter 42 is acquired in advance by tracing an optical path of the light beam toward an emission point of the laser beam from the optical fiber 30 using a ray tracing method. The data acquired in advance is stored in a storage device of the calculation device 51. Then, based on the data on the incident angle on the first beam splitter 42 at each data position on the imaging surface of the observation device 50 acquired in advance, the incident angle on the first beam splitter 42 is found from the data position on the imaging surface of the observation device 50 in the output data of the observation device 50 according to the incidence of the laser beam. Furthermore, based on the data on the dependency of the reflectance of the first beam splitter 42 on the incident angle acquired in advance, with the reflectance at the incident angle on the first beam splitter 42 at the position of the optical axis 10 as a reference in the output data of the observation device 50, an energy intensity value at another position is corrected.

More specifically, for example, the present invention can be carried out as follows. A coordinate value on the X axis and a coordinate value on the Y axis of data output from the observation device 50 at a certain position are defined as x and y, respectively. Then, when a reflectance at the incident angle on the first beam splitter 42 at the position of the optical axis 10 is defined as i, a reflectance at the incident angle on the first beam splitter 42 of a laser beam reaching the certain coordinate position (x, y) on the imaging surface of the observation device 50 is defined as j, and an energy intensity value at the certain coordinate position (x, y) in the output data of the observation device 50 is defined as E, a corrected energy intensity value E′ at the certain coordinate position (x, y) of the observation device 50 can be E′=(i/j). E. That is, the energy intensity in the output data can be corrected in the Y-axis direction of the output data, based on the reflectance value of the first beam splitter 42 corresponding to the incident angle of the laser beam on the first beam splitter 42. In this manner, the energy intensity distribution of the laser beam measured by the observation device 50, which is a distribution biased in the Y-axis direction, can be corrected to an energy intensity distribution similar to the energy intensity distribution of the laser beam incident on the first beam splitter 42 using the calculation device 51. Therefore, it is preferable that the calculation device 51 has a numerical calculation function capable of performing the above-described calculation.

Note that, since the first beam splitter 42 is disposed to be inclined at the angle α with the X axis as a rotation axis, the incident angle of the laser beam on the optical surface of the first beam splitter 42 does not change in the X-axis direction. Therefore, the energy intensity distribution of the laser beam measured by the observation device 50 is not biased in the X-axis direction with respect to the energy intensity distribution of the laser beam incident on the attenuation mechanism 40. From the above, in the second embodiment of the laser beam measurement device, it is preferable that the calculation device 51 having a numerical calculation function with respect to output data from the observation device 50 is included to correct the energy intensity of the output data in the Y-axis direction.

In the first embodiment of the laser beam measurement device, the measured image of the laser beam transmitted through the first beam splitter 41 is distorted in the Y-axis direction due to astigmatism. On the other hand, in the second embodiment of the laser beam measurement device, the attenuation mechanism 40 of the laser beam measurement device according to the second embodiment uses light reflected by the first beam splitter 42. That is, the beam emitted from the first beam splitter 42 converges at the same focal length, and astigmatism does not occur. Therefore, in the second embodiment of the laser beam measurement device, a distortion in the Y-axis direction does not occur in the image shape of the output data of the laser beam, and a correction of the output data of the laser beam for the distortion in the Y-axis direction is not necessarily required.

Furthermore, in the configuration of the attenuation mechanism 40 illustrated in FIG. 4, in a case where light attenuation is insufficient for a laser beam to have an energy intensity so as to be incident on the observation device 50, an optical element such as an ND filter capable of attenuating the laser beam may be arranged between the first beam splitter 42 and the observation device 50.

As described above, the laser beam measurement device according to the second embodiment of the present invention includes an attenuation mechanism 40 including a first beam splitter 42 closer to the spot than the laser beam irradiation optical unit 31, an observation device 50 that measures information on an image of a laser beam formed at the position of the spot, and a calculation device 51 that performs a numerical calculation on output data of the observation device 50 to perform a correction. When certain coordinate axes orthogonal to each other on a plane perpendicular to the optical axis 10 with their origins being located on the optical axis 10 are defined as X and Y axes, the first beam splitter 42 is disposed to be inclined at an angle α in a range of 30 degrees or more and 60 degrees or less with respect to the plane perpendicular to the optical axis 10 with the X axis as a rotation axis. As a result, even though the power of the laser beam that can be incident is as large as 1 kW at normal times, the laser beam can be output from the attenuation mechanism 40 after the energy intensity of the laser beam is reduced to such an extent that the observation device 50 that acquires image data from an image sensor, a camera, or the like is not destroyed. Then, with respect to the Y-axis direction of the output data from the observation device 50, using the calculation device 51 having a numerical calculation function, the energy intensity in the Y-axis direction of the output data can be corrected. By using the corrected output data, an energy intensity distribution at the spot can be measured to be similar to the energy intensity distribution of the laser beam incident on the attenuation mechanism 40, with an image shape similar to the image shape of the laser beam incident on the attenuation mechanism 40.

### Third Embodiment of Laser Beam Measurement Device

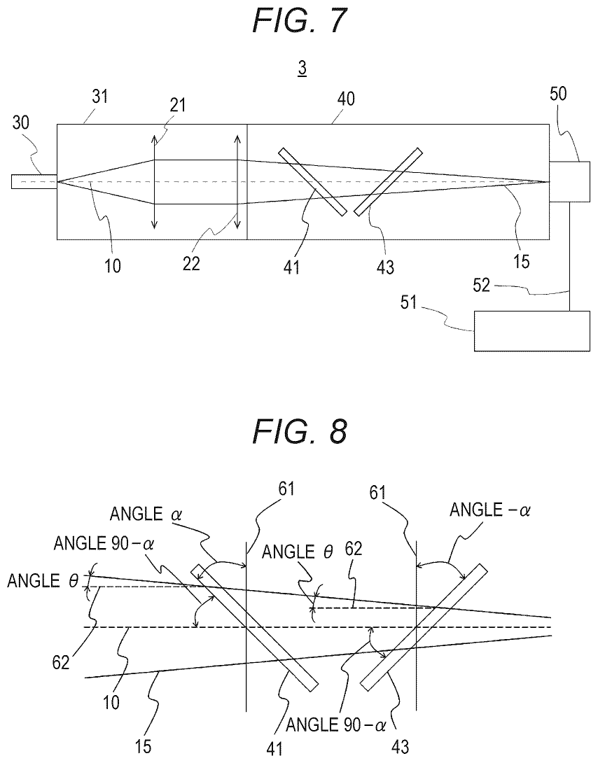

As illustrated in FIG. 7, a laser beam measurement device according to a third embodiment of the present invention has a configuration in which a second beam splitter 43 is added to the attenuation mechanism 40 of the laser beam measurement device according to the first embodiment illustrated in FIG. 1. That is, the observation device 50 is configured to read images of spots formed by transmitted light of a laser beam incident on the first beam splitter 41 and the second beam splitter 43. The second beam splitter 43 may be disposed in such a manner that the center position of the second beam splitter 43 coincides with the optical axis 10, but may be disposed in such a manner that at least the laser beam irradiation orbit 15 is within the optically effective surface of the second beam splitter 43. When certain coordinate axes orthogonal to each other on the plane perpendicular to the optical axis 10 with their origins being located on the optical axis 10 are defined as X and Y axes, the second beam splitter 43 is disposed to be inclined at an angle −α with respect to the plane perpendicular to the optical axis 10 with an X′ axis as a rotation axis, the X′ axis being parallel to the X axis and passing through the optical axis. Here, the position at which the second beam splitter 43 is disposed in the optical axis direction is closer to the spot than the first beam splitter 41 in FIG. 7, but may be closer to the condenser lens 22 (the laser oscillator) than the first beam splitter 41. Note that the plane perpendicular to the optical axis 10 in FIG. 7 is a plane perpendicular to the optical axis 10 including only one point on the optical axis 10, the X axis is a straight line on the plane perpendicular to the optical axis 10, perpendicularly penetrating the view of FIG. 7 when taken as a plane with the optical axis 10 as an origin, and the Y axis is a straight line on the plane perpendicular to the optical axis 10, being orthogonal to the X axis on the view of FIG. 7 when taken as a plane with the optical axis 10 as an origin. In the present invention, the X axis and the Y axis are defined in the same manner as described above in the other drawings.

The first beam splitter 41 and the second beam splitter 43 have a function of splitting an incident laser beam into transmitted light and reflected light. In FIG. 7, the laser beam irradiation orbit 15 includes an orbit of a laser beam incident on the first beam splitter 41 and the second beam splitter 43 and an orbit of light transmitted through the first beam splitter 41 and the second beam splitter 43, and light reflected from the first beam splitter 41 and the second beam splitter 43 is not illustrated. That is, in the third embodiment, the observation device 50 observes light transmitted through the first beam splitter 41 and the second beam splitter 43. At this time, when the incident angle of the laser beam on the first beam splitter 41 and on the second beam splitter 43 is 45 degrees with respect to the optical surfaces of the first beam splitter 41 and the second beam splitter 43, it is preferable that the laser beam transmittance of the first beam splitter 41 and the second beam splitter 43 is 0.1% or more and 5.0% or less. This is because, with respect to an incident laser beam, an energy intensity of a transmitted light component of the laser beam decreases. It is preferable that the first beam splitter 41 and the second beam splitter 43 have a characteristic in which “changes of transmittances when an incident angle of the laser beam on the first beam splitter 41 and the second beam splitter 43 is other than 45°” “relative to the transmittance at 45°” are the same with respect to the optical surfaces of the first beam splitter 41 and the second beam splitter 43. Unnecessary reflected light reflected by the first beam splitter 41 and the second beam splitter 43 may be emitted to a copper plate or the like processed to have a black surface so as to easily absorb the laser beam for absorptive radiation.

Note that the thicknesses of the first beam splitter 41 and the second beam splitter 43 are not particularly limited as long as they can be used for the attenuation mechanism 40, and the first beam splitter 41 and the second beam splitter 43 may have the same thickness or have different thicknesses.

In addition, in the plate-type beam splitter, transmitted light is shifted with respect to the optical axis 10 by refraction (a shift of transmitted light is not illustrated in FIGS. 7 and 8). However, since the attenuation mechanism 40 is for measuring an energy intensity distribution and an image shape of the laser beam using the observation device 50, the shift of the transmitted light with respect to the optical axis 10 does not cause a problem.

The beam splitter is usually designed in such a manner that a predetermined transmittance or reflectance is obtained with an incident angle on the beam splitter with respect to an optical surface of the beam splitter being 45°. When the incident angle of the laser beam on the beam splitter continuously changes from 45° to different values, the transmittance value of the beam splitter continuously changes to different values. In FIG. 7, as indicated by the irradiation orbit 15, since a laser beam is incident on the first beam splitter 41 and the second beam splitter 43 via the condenser lens 22, the incident angle of the laser beam on the first beam splitter 41 and the second beam splitter 43 continuously changes in the Y-axis direction described above. In a case where the transmittance characteristic of the first beam splitter 41 is a characteristic illustrated in FIG. 2, if only one-sheet first beam splitter 41 is used as the attenuation mechanism 40, when it is assumed that the minimum incident angle on the first beam splitter 41 is 40° and the maximum incident angle on the first beam splitter 41 is 50°, the transmittance ratio of transmitted light at the maximum incident angle to transmitted light at the minimum incident angle is 0.92/0.75=1.2 times. In this case, the energy intensity distribution of the laser beam at the spot cannot be correctly measured.

An enlarged view of a portion where the first beam splitter 41 and the second beam splitter 43 are located is illustrated in FIG. 8. In FIG. 8, the laser beam irradiation orbit 15 includes an orbit of a laser beam incident on the first beam splitter 41 and the second beam splitter 43 and an orbit of light transmitted through the first beam splitter 41 and the second beam splitter 43, and light reflected from the first beam splitter 41 and the second beam splitter 43 is not illustrated. Here, the first beam splitter 41 is disposed to be inclined at an angle in the above-described range with respect to the plane 61 perpendicular to the optical axis 10 with the X axis as a rotation axis, whereas the second beam splitter 43 is disposed to be inclined at the angle −α with respect to the plane 61 perpendicular to the optical axis 10 with the X′ axis as a rotation axis. As illustrated in FIG. 8, a value of an incident angle of the laser beam on the first beam splitter 41 with respect to the optical surface of the beam splitter at the position of the optical axis 10 is (90−α) expressed as an angle smaller than 90°. Similarly, a value of an incident angle of the laser beam on the second beam splitter 43 with respect to the optical surface of the beam splitter at the position of the optical axis 10 is (90−α) expressed as an angle smaller than 90°. For example, an incident angle of the laser beam at the position of the upper end of the irradiation orbit 15 on the first beam splitter 41 with respect to the optical surface of the beam splitter is expressed by (90−α)−θ, with the value of the incident angle at the position of the optical axis 10 as a reference. The angle θ is an incident angle of the laser beam at the position of the upper end of the irradiation orbit 15 with respect to a virtual line 62 parallel to the optical axis 10, that is, an angle of a difference from the incident angle at the position of the optical axis 10.

At this time, transmitted light of the laser beam incident on and transmitted through the first beam splitter 41 at an angle of (90−α)−θ at the position of the upper end of the irradiation orbit 15 is incident on the second beam splitter 43 at an angle of (90−α)+θ. That is, the laser beam at the position of the upper end of the irradiation orbit 15 of the first beam splitter 41 is incident on the first beam splitter 41 at an incident angle shifted by an angle −θ with respect to the incident angle at the position of the optical axis 10, and the transmitted light of the laser beam at the position of the upper end of the irradiation orbit 15 of the first beam splitter 41 is incident on the second beam splitter 43 at an incident angle shifted by an angle θ with respect to the incident angle at the position of the optical axis 10. As described above, when the incident angle of the laser beam on the beam splitter continuously changes from 45° to different values, the transmittance value of the beam splitter continuously changes to different values. Therefore, the total transmittance of the transmitted light of the laser beam transmitted through the first beam splitter 41 and the transmitted light of the laser beam transmitted through the second beam splitter 43 at the position of the upper end of the irradiation orbit 15 is almost equal to the total transmittance of the transmitted light of the laser beam transmitted through the first beam splitter 41 and the transmitted light of the laser beam transmitted through the second beam splitter 43 at the position of the optical axis 10. Although the transmitted light of the laser beam through the first beam splitter 41 at the position of the upper end of the irradiation orbit 15 has been described as an example, but the laser beam may be a laser beam at any position of the irradiation orbit 15.

As described above, since the laser beam measurement device according to the third embodiment has a configuration in which the second beam splitter 43 is added to the attenuation mechanism 40 of the laser beam measurement device according to the first embodiment, the energy intensity distribution of the laser beam measured by the observation device 50 with respect to the energy intensity distribution of the laser beam incident on the attenuation mechanism 40 can be correctly measured, not biased in the Y-axis direction.

Note that, since the first beam splitter 41 is disposed to be inclined at the angle α with the X axis as a rotation axis and the second beam splitter 43 is disposed to be inclined at the angle −α with the X′ axis as a rotation axis, the incident angles of the laser beam on the optical surfaces of the first beam splitter 41 and the second beam splitter 43 do not change in the X-axis direction.

Here, as illustrated in FIG. 8, the first beam splitter 41 is disposed to be inclined at an angle α in a range of 30 degrees or more and 60 degrees or less with respect to a plane perpendicular to the optical axis 10 with the X axis as a rotation axis, and the second beam splitter 43 is disposed to be inclined at an angle −α with respect to a plane perpendicular to the optical axis 10 with the X′ axis as a rotation axis, the X′ axis being parallel to the X axis and passing through the optical axis. When the plate-type beam splitter is disposed to be inclined with respect to the plane perpendicular to the optical axis in this manner, in a case where collimated light is incident on the beam splitter, the orbit of light emitted from the beam splitter is shifted with respect to the incident light due to refraction. In a case where focused light is incident on the beam splitter, in addition to the shift of the orbit, astigmatism occurs so that the emitted light is focused at the same focal length the X-axis direction, but the emitted light is focused at different focal lengths in the Y-axis direction. That is, an image of the transmitted light of the laser beam transmitted through the first beam splitter 41 and the second beam splitter 43 is distorted in the Y-axis direction due to astigmatism.

The measured image shape of the output data of the laser beam distorted in the Y-axis direction can be corrected by a numerical calculation using the calculation device 51. Hereinafter, an output data correction method for correction to an image shape similar to the image shape of the laser beam incident on the attenuation mechanism 40 by performing a numerical calculation for correcting the image shape of the output data in the Y-axis direction will be described. However, the output data correction method is not limited to the following description as long as the image shape can be corrected in the Y-axis direction of the output data.

A first method is an output data correction method that can be used in a case where an outer peripheral contour of an image shape of the laser beam incident on the attenuation mechanism 40 on a plane perpendicular to the optical axis 10 is a circle. In this case, since the outer peripheral contour of the image shape of the laser beam incident on the attenuation mechanism 40 on the plane perpendicular to the optical axis 10 is a circle, a ratio of the size in the X-axis direction to the size in the Y-axis direction in the outer peripheral contour of the image shape of the laser beam incident on the attenuation mechanism 40 is 1:1. At this time, since an image on the X axis of the image shape at the spot of the laser beam output from the attenuation mechanism 40 is not distorted, the Y-axis position of the output data can be corrected using a ratio of a diameter of an image on the Y axis with respect to a diameter of the image on the X axis.

For example, on the imaging surface of the observation device 50, a diameter value of an image in the X-axis direction is defined as c, a diameter value of an image in the Y-axis direction is defined as d, and a coordinate value on the X axis and a coordinate value on the Y axis of data output from the observation device 50 at a certain position is defined as x and y, respectively. At this time, a corrected data position of the certain position can be represented by x for a coordinate value on the X axis and (c/d)·y for a coordinate value on the Y axis. That is, by performing the numerical calculation for correcting the coordinate position of the output data from the observation device 50 in the Y-axis direction using the calculation device 51 as described above, corrected output data that is an image shape similar to the image shape of the laser beam incident on the attenuation mechanism 40 is obtained. By displaying the corrected output data on a display device, the output data can be observed as the image shape at the spot. Therefore, it is preferable that the calculation device 51 has a numerical calculation function capable of performing the above-described calculation.

A second method is an output data correction method that can be used in a case where outer peripheral contours of image shapes of laser beams incident on the attenuation mechanism 40 on a plane perpendicular to the optical axis 10 are a circle and shapes other than a circle. First, optical calculations are performed based on optical information about an optical system closer to the light source (the laser oscillator) than the attenuation mechanism 40, that is, image shapes of laser beams of the light source and optical information about the collimator lens 21 and the condenser lens 22, to acquire data (primary data) on the image shapes of the laser beams at a plurality of spot positions (focal length positions) when the attenuation mechanism 40 is not included in advance, and the acquired data is stored in the storage device of the calculation device 51. Next, in an optical system including the attenuation mechanism 40, a laser beam is emitted, and data (secondary data) on an image shape of the laser beam is acquired from the observation device 50 at a certain position set as a spot position.

Data on an image shape at the same spot position (focal length position) as the secondary data is acquired is selected from the primary data. A largest value of the size of the image in the X-axis direction of the image shape is defined as e, and a value of the smallest size of the image in the Y-axis direction is defined as f. From the secondary data, a largest value of the size of the image in the X-axis direction of the image shape is defined as g, and a value of the smallest size of the image in the Y-axis direction is defined as h. At this time, when a coordinate value on the X axis and a coordinate value on the Y axis of the data output from the observation device 50 at the certain position are x and y, respectively, a corrected data position of the certain position can be represented by x for a coordinate value on the X axis and ((f·g)/(e·h))·y for a coordinate value on the Y axis. That is, by performing the numerical calculation for correcting the coordinate position of the output data from the observation device 50 in the Y-axis direction using the calculation device 51 as described above, corrected output data is obtained as an image shape similar to the image shape of the laser beam incident on the attenuation mechanism 40. By displaying the corrected output data on a display device, the output data can be observed as the image shape at the spot. Therefore, it is preferable that the calculation device 51 has a numerical calculation function capable of performing the above-described calculation.

Note that, in a case where the diameter value of the image on the X axis or the Y axis or the largest value of the size of the image in the X-axis direction or the Y-axis direction cannot be clearly determined in the above description, from data on a contour of an image with a predetermined intensity (e.g., 10%) when the largest value of the energy intensity of the laser beam measured by the observation device 50 is 100%, a diameter value of the image on the X axis or the Y axis or a largest value of the size of the image in the X-axis direction or the Y-axis direction may be determined.

That is, with respect to the Y-axis direction of the output data, by correcting the coordinate position of the output data in the Y-axis direction based on a value of a ratio between the largest value of the size of the image in the X-axis direction of the image shape and the largest value of the size of the image in the Y-axis direction for the image shape on the observation device 50, the coordinate position of the output data can be corrected in the Y-axis direction. By using the first method, the second method, or the like described above, the image shape of the laser beam at the spot distorted in the Y-axis direction measured by the observation device 50 can be corrected to a correct image shape (an image shape similar to the image shape of the laser beam incident on the attenuation mechanism 40) using the calculation device 51.

From the above, in the third embodiment of the laser beam measurement device, it is preferable that the calculation device 51 having a numerical calculation function with respect to output data from the observation device 50 is included to correct the energy intensity of the output data in the Y-axis direction and correct the coordinate position of the output data in the Y-axis direction.

In the configuration of the attenuation mechanism 40 illustrated in FIG. 8, in a case where light attenuation is insufficient for a laser beam to have an energy intensity so as to be incident on the observation device 50, an optical element such as an ND filter capable of attenuating the laser beam may be arranged between a beam splitter group including the first beam splitter 41 and the second beam splitter 43 and the observation device 50.

As described above, the laser beam measurement device according to the third embodiment of the present invention includes an attenuation mechanism 40 including a first beam splitter 41 and a second beam splitter 43 closer to the spot than the laser beam irradiation optical unit 31, an observation device 50 that measures information on an image of a laser beam formed at the position of the spot, and a calculation device 51 that performs a numerical calculation on output data of the observation device 50 to perform a correction. When certain coordinate axes orthogonal to each other on a plane perpendicular to the optical axis 10 with their origins being located on the optical axis 10 are defined as X and Y axes, the first beam splitter 41 is disposed to be inclined at an angle α in a range of 30 degrees or more and 60 degrees or less with respect to the plane perpendicular to the optical axis 10 with the X axis as a rotation axis, and the second beam splitter 43 is disposed to be inclined at an angle −α with respect to a plane perpendicular to the optical axis 10 with the X′ axis as a rotation axis, the X′ axis being parallel to the X axis and passing through the optical axis 10. As a result, the power of the laser beam that can be incident is as large as 1 kW at normal times, and the laser beam can be output from the attenuation mechanism 40 after the energy intensity of the laser beam is reduced to such an extent that the observation device 50 that acquires image data from an image sensor, a camera, or the like is not destroyed. Then, with respect to the Y-axis direction of the output data from the observation device 50, using the calculation device 51 having a numerical calculation function, the coordinate position in the Y-axis direction of the output data can be corrected. By using the corrected output data, an energy intensity distribution at the spot can be measured to be similar to the energy intensity distribution of the laser beam incident on the attenuation mechanism 40, with an image shape similar to the image shape of the laser beam incident on the attenuation mechanism 40.

[Collimator Lens]

The collimator lens 21 is an optical element for collimating a laser beam radially output from an output end of the optical fiber 30.

[Condenser Lens]

The condenser lens 22 is an optical element for condensing the laser beam converted into collimated light by the collimator lens 21 on a spot.

[Beam Splitter]

Beam splitters include cube-type beam splitters and plate-type beam splitters, but it is preferable that the beam splitter according to the present invention is a plate-type beam splitter. The shape of the plate-type beam splitter is not particularly limited as long as it can be used for the attenuation mechanism according to the present invention, and may be a quadrangle, a polygon, or a circle. Further, the plate-type beam splitter may be a polarizing beam splitter or a non-polarizing beam splitter. The cube-type beam splitter is not preferable, because there are a plurality of planes perpendicular to an incident direction of a laser beam, causing light returning to the laser oscillator (the light source) of a laser beam, and resulting in unstable oscillation of the laser. In addition, the cube-type beam splitter usually has a structure in which inclined surfaces of two prisms are joined to each other using a joining resin. The cube-type beam splitter has a larger volume than the plate-type beam splitter. Therefore, the cube-type beam splitter is not preferable, for example, because the resin used for joining is easily denatured by heat generated when a laser beam is incident, the generated heat is difficult to dissipate and is easily damaged as compared with that in the plate-type beam splitter.

[Observation Device]

The observation device 50 is not particularly limited as long as it can observe an irradiation position and an image shape of a laser beam and an energy intensity distribution of the laser beam as information on the image of the laser beam at the spot, and any observation device such as an image sensor, e.g., a CCD or a CMOS, can be used. Then, it is preferable that the observation device 50 can output an observation result as data. This is because a numerical calculation can be performed on the data output from the observation device 50 using the calculation device 51. In addition, it is preferable that the attenuation mechanism 40 to which the observation device 50 is connected is detachable from the laser beam irradiation optical unit 31. When the attenuation mechanism 40 is connected to the laser beam irradiation optical unit 31, it is preferable that an imaging surface (observation point) of the observation device 50 is located at the same place as a surface of a workpiece on which a spot is to be formed during laser processing. Furthermore, it is preferable that the center of the imaging surface of the observation device 50 is located on the optical axis 10 and at the center of the processed portion of the object to be processed. This is because the position of the laser beam and the energy intensity distribution of the laser beam can be observed at the same position as the surface of the workpiece on which a spot is to be formed.

### [Calculation Device]

Any calculation device can used for the calculation device 51 as long as it can perform programming and can perform a numerical calculation on the data output from the observation device 50 described above, but preferably includes a storage device that stores data. This is because an optical calculation can be performed based on the optical information of the optical system arranged in the laser beam irradiation optical unit 31, and data (primary data) on image shapes of laser beams at a plurality of spot positions (focal length positions) can be acquired in advance and stored in the storage device. This is also because, in the optical system in which the attenuation mechanism 40 is also included in the laser beam irradiation optical unit 31, after a laser beam is emitted and data (secondary data) on an image shape of the laser beam is acquired from the observation device 50 at a certain position set as a spot position, data on an image shape at the same spot position (focal length position) as the secondary data is acquired can be selected from the primary data, and the calculation device 51 can correct the coordinate position of the secondary data in the Y-axis direction.

In addition, it is preferable that the calculation device 51 is connected to the observation device 50 by the connection cable 52 capable of transmitting and receiving electronic data. This is because control signals can be exchanged between the observation device 50 and the calculation device 51, or output data observed by the observation device 50 can be taken into the calculation device 51 to perform a numerical calculation. Note that the connection cable 52 may have any form as long as what has been described above can be achieved, and may be a cable using a metal wire or an optical fiber, or wireless communication such as radio wave communication or infrared communication may be used rather than the cable.

Although data corrected by the calculation device 51 is not illustrated in FIGS. 1, 4, and 7, the image shape of the laser beam or the energy intensity distribution of the laser beam can be displayed by using a display device.

### 2. Embodiment of Output Data Correction Method

A correction method for correcting data output from the observation device 50 by performing numerical calculations according to the present invention is a correction method for correcting an energy intensity in the Y-axis direction of the output data and correcting a coordinate position in the Y-axis direction of the output data by performing numerical calculations using the functions of the calculation device 51 described in the first embodiment of the laser beam measurement device, the second embodiment of the laser beam measurement device, and the third embodiment of the laser beam measurement device.

### [Method of Correcting Energy Intensity in Y-Axis Direction]

The measured energy intensity distribution of the output data of the laser beam biased in the Y-axis direction can be corrected by a numerical calculation using the calculation device 51. Hereinafter, an output data correction method for correction to an energy intensity distribution similar to the energy intensity distribution of the laser beam incident on the attenuation mechanism 40 by performing a numerical calculation for correcting the energy intensity distribution of the output data in the Y-axis direction will be described. However, the output data correction method is not limited to the following description as long as the energy intensity distribution position of the output data can be corrected in the Y-axis direction. Note that, as described above, in the laser beam measurement device according to the third embodiment, since the attenuation mechanism 40 is constituted by the first beam splitter 41 and the second beam splitter 43, the energy intensity distribution of the output data of the laser beam is not biased in the Y-axis direction, and a correction of the output data of the laser beam for the bias in the Y-axis direction is not necessarily required.

In the laser beam measurement device according to the first embodiment, first, data on the dependency of the transmittance of the first beam splitter 41 on the incident angle is acquired in advance. Furthermore, for example, at each data position on the imaging surface of the spot position observation device 50, data on the incident angle on the first beam splitter 41 is acquired in advance by tracing an optical path of the light beam toward an emission point of the laser beam from the optical fiber 30 using a ray tracing method. The data acquired in advance is stored in a storage device of the calculation device 51. Then, based on the data on the incident angle on the first beam splitter 41 at each data position on the imaging surface of the observation device 50 acquired in advance, the incident angle on the first beam splitter 41 is found from the data position on the imaging surface of the observation device 50 in the output data of the observation device 50 according to the incidence of the laser beam. Furthermore, based on the data on the dependency of the transmittance of the first beam splitter 41 on the incident angle acquired in advance, with the transmittance at the incident angle on the first beam splitter 41 at the position of the optical axis 10 as a reference in the output data of the observation device 50, an energy intensity value at another position is corrected.

More specifically, for example, the present invention can be carried out as follows. A coordinate value on the X axis and a coordinate value on the Y axis of data output from the observation device 50 at a certain position are defined as x and y, respectively. Then, when a transmittance at the incident angle on the first beam splitter 41 at the position of the optical axis 10 is defined as a, a transmittance at the incident angle on the first beam splitter 41 of a laser beam reaching the certain coordinate position (x, y) on the imaging surface of the observation device 50 is defined as b, and an energy intensity value at the certain coordinate position (x, y) in the output data of the observation device 50 is defined as E, a corrected energy intensity value E′ at the certain coordinate position (x, y) of the observation device 50 can be E′=(a/b)·E. That is, the energy intensity in the output data can be corrected in the Y-axis direction of the output data, based on the transmittance value of the first beam splitter 41 corresponding to the incident angle of the laser beam on the first beam splitter 41. In this manner, the energy intensity distribution of the laser beam measured by the observation device 50, which is a distribution biased in the Y-axis direction, can be corrected to an energy intensity distribution similar to the energy intensity distribution of the laser beam incident on the attenuation mechanism 40 using the calculation device 51.

In the laser beam measurement device according to the second embodiment, first, data on the dependency of the reflectance of the first beam splitter 42 on the incident angle is acquired in advance. Furthermore, for example, at each data position on the imaging surface of the spot position observation device 50, data on the incident angle on the first beam splitter 42 is acquired in advance by tracing an optical path of the light beam toward an emission point of the laser beam from the optical fiber 30 using a ray tracing method. The data acquired in advance is stored in a storage device of the calculation device 51. Then, based on the data on the incident angle on the first beam splitter 42 at each data position on the imaging surface of the observation device 50 acquired in advance, the incident angle on the first beam splitter 42 is found from the data position on the imaging surface of the observation device 50 in the output data of the observation device 50 according to the incidence of the laser beam. Furthermore, based on the data on the dependency of the reflectance of the first beam splitter 42 on the incident angle acquired in advance, with the reflectance at the incident angle on the first beam splitter 42 at the position of the optical axis 10 as a reference in the output data of the observation device 50, an energy intensity value at another position is corrected.

More specifically, for example, the present invention can be carried out as follows. A coordinate value on the X axis and a coordinate value on the Y axis of data output from the observation device 50 at a certain position are defined as x and y, respectively. Then, when a reflectance at the incident angle on the first beam splitter 42 at the position of the optical axis 10 is defined as i, a reflectance at the incident angle on the first beam splitter 42 of a laser beam reaching a coordinate position (x, y) of a certain position on the imaging surface of the observation device 50 is defined as j, and an energy intensity value at the certain coordinate position (x, y) in the output data of the observation device 50 is defined as E, a corrected energy intensity value E′ at the certain coordinate position (x, y) of the observation device 50 can be E′=(i/j)·E. That is, the energy intensity in the output data can be corrected in the Y-axis direction of the output data, based on the reflectance value of the first beam splitter 42 corresponding to the incident angle of the laser beam on the first beam splitter 42. In this manner, the energy intensity distribution of the laser beam measured by the observation device 50, which is a distribution biased in the Y-axis direction, can be corrected to an energy intensity distribution similar to the energy intensity distribution of the laser beam incident on the attenuation mechanism 40 using the calculation device 51.

### [Method of Correcting Coordinate Position in Y-Axis Direction]

The measured image shape of the output data of the laser beam distorted in the Y-axis direction can be corrected by a numerical calculation using the calculation device 51. Hereinafter, an output data correction method for correction to an image shape similar to the image shape of the laser beam incident on the attenuation mechanism 40 by performing a numerical calculation for correcting the image shape of the output data in the Y-axis direction, in the laser beam measurement device according to the first embodiment and in the laser beam measurement device according to the third embodiment, will be described. However, the output data correction method is not limited to the following description as long as the image shape of the output data can be corrected in the Y-axis direction. Note that, as described above, in the second embodiment of the laser beam measurement device, since astigmatism does not occur in the attenuation mechanism 40, a distortion in the Y-axis direction does not occur in the image shape of the output data of the laser beam, and a correction of the output data of the laser beam for the distortion in the Y-axis direction is not necessarily required.

A first method is an output data correction method that can be used in a case where an outer peripheral contour of an image shape of the laser beam incident on the attenuation mechanism 40 on a plane perpendicular to the optical axis 10 is a circle. In this case, since the outer peripheral contour of the image shape of the laser beam incident on the attenuation mechanism 40 on the plane perpendicular to the optical axis 10 is a circle, a ratio of the size in the X-axis direction to the size in the Y-axis direction in the outer peripheral contour of the image shape of the laser beam incident on the attenuation mechanism 40 is 1:1. At this time, since an image on the X axis of the image shape at the spot of the laser beam output from the attenuation mechanism 40 is not distorted, the Y-axis position of the output data can be corrected using a ratio of a diameter of an image on the Y axis with respect to a diameter of the image on the X axis. For example, on the imaging surface of the observation device 50, a diameter value of an image in the X-axis direction is defined as c, a diameter value of an image in the Y-axis direction is defined as d, and a coordinate value on the X axis and a coordinate value on the Y axis of data output from the observation device 50 at a certain position is defined as x and y, respectively. At this time, a corrected data position of the certain position can be represented by x for a coordinate value on the X axis and (c/d)·y for a coordinate value on the Y axis. That is, by performing the numerical calculation for correcting the coordinate position of the output data from the observation device 50 in the Y-axis direction using the calculation device 51 as described above, corrected output data that is an image shape similar to the image shape of the laser beam incident on the attenuation mechanism 40 is obtained. By displaying the corrected output data on a display device, the output data can be observed as the image shape at the spot.

A second method is an output data correction method that can be used in a case where outer peripheral contours of image shapes of laser beams incident on the attenuation mechanism 40 on a plane perpendicular to the optical axis 10 are a circle and shapes other than a circle. First, optical calculations are performed based on optical information about an optical system closer to the light source than the attenuation mechanism 40, that is, image shapes of laser beams of the light source and optical information about the collimator lens 21 and the condenser lens 22, to acquire data (primary data) on the image shapes of the laser beams at a plurality of spot positions (focal length positions) when the attenuation mechanism 40 is not included in advance, and the acquired data is stored in the storage device of the calculation device 51. Next, in an optical system including the attenuation mechanism 40, a laser beam is emitted, and data (secondary data) on an image shape of the laser beam is acquired from the observation device 50 at a certain position set as a spot position.

Data on an image shape at the same spot position (focal length position) as the secondary data is acquired is selected from the primary data. A largest value of the size of the image in the X-axis direction of the image shape is defined as e, and a value of the smallest size of the image in the Y-axis direction is defined as f. From the secondary data, a largest value of the size of the image in the X-axis direction of the image shape is defined as g, and a value of the smallest size of the image in the Y-axis direction is defined as h. At this time, when a coordinate value on the X axis and a coordinate value on the Y axis of the data output from the observation device 50 at the certain position are x and y, respectively, a corrected data position of the certain position can be represented by x for a coordinate value on the X axis and ((f·g)/(e·h))·y for a coordinate value on the Y axis. That is, by performing the numerical calculation for correcting the coordinate position of the output data from the observation device 50 in the Y-axis direction using the calculation device 51 as described above, corrected output data is obtained as an image shape similar to the image shape of the laser beam incident on the attenuation mechanism 40. By displaying the corrected output data on a display device, the output data can be observed as the image shape at the spot.

Note that, in a case where the diameter value of the image on the X axis or the Y axis or the largest value of the size of the image in the X-axis direction or the Y-axis direction cannot be clearly determined in the above description, from data on a contour of an image with a predetermined intensity (e.g., 10%) when the largest value of the energy intensity of the laser beam measured by the observation device 50 is 100%, a diameter value of the image on the X axis or the Y axis or a largest value of the size of the image in the X-axis direction or the Y-axis direction may be determined.

That is, with respect to the Y-axis direction of the output data, by correcting the coordinate position of the output data in the Y-axis direction based on a value of a ratio between the largest value of the size of the image in the X-axis direction of the image shape and the largest value of the size of the image in the Y-axis direction for the image shape on the observation device 50, the coordinate position of the output data can be corrected in the Y-axis direction. By using the first method, the second method, or the like described above, the image shape of the laser beam at the spot distorted in the Y-axis direction measured by the observation device 50 can be corrected to a correct image shape (an image shape similar to the image shape of the laser beam incident on the attenuation mechanism 40) using the calculation device 51.

The embodiment of the present invention described above is one aspect of the present invention, and can be appropriately modified without departing from the gist of the present invention. In addition, the present invention will be more specifically described below using the following examples, but the present invention is not limited to the following examples.

### Example 1

In Example 1, the configuration of the laser beam measurement device according to the first embodiment illustrated in FIG. 1, which was the first embodiment of the laser beam measurement device, was used. Then, the condenser lens 22 having an annular shape conversion function was used so that the image shape at the spot was annular. As the plate-type first beam splitter 41, a beam splitter having a thickness of 3 mm and a transmittance characteristic illustrated in FIG. 2 was used. Then, the first beam splitter 41 was disposed to be inclined by 45 degrees with the X axis as a rotation axis. In the first embodiment of the laser beam measurement device, in data output from the observation device 50, an image shape is distorted in the Y-axis direction and an energy intensity distribution is biased in the Y-axis direction. This was corrected by the following method.

In the measured image shape of the output data of the laser beam distorted in the Y-axis direction, since the outer peripheral contour of the image shape of the laser beam incident on the attenuation mechanism 40 on the plane perpendicular to the optical axis 10 is a circle, a ratio of the size in the X-axis direction to the size in the Y-axis direction in the outer peripheral contour of the image shape of the laser beam incident on the attenuation mechanism 40 is 1:1. At this time, the image on the X axis of the image shape at the spot of the laser beam output from the attenuation mechanism 40 is not distorted. In addition, on the imaging surface of the observation device 50, a diameter value of an image in the X-axis direction is defined as c, a diameter value of an image in the Y-axis direction is defined as d, and a coordinate value on the X axis and a coordinate value on the Y axis of data output from the observation device 50 at a certain position is defined as x and y, respectively. At this time, a corrected data position of the certain position can be corrected to x for a coordinate value on the X axis and (c/d)·y for a coordinate value on the Y axis. In this manner, the image shape distorted in the Y-axis direction measured by the observation device 50 was corrected to an image shape similar to the image shape of the laser beam incident on the attenuation mechanism 40 using the calculation device 51.

Furthermore, the measured energy intensity distribution of the output data of the laser beam biased in the Y-axis direction of was corrected as follows. First, at each data position on the imaging surface of the spot position observation device 50, data on the incident angle on the first beam splitter 41 was acquired in advance by tracing an optical path of the light beam toward an emission point of the laser beam from the optical fiber 30 using a ray tracing method. As a result, an incident angle of the data output from the observation device 50 on the first beam splitter 41 can be specified from the data position on the imaging surface of the observation device 50. Here, a coordinate value on the X axis and a coordinate value on the Y axis of data output from the observation device 50 at a certain position are defined as x and y, respectively. Then, when a transmittance at the incident angle on the first beam splitter 41 at the position of the optical axis 10 is defined as a, a transmittance at the incident angle on the first beam splitter 41 of a laser beam reaching the certain coordinate position (x, y) on the imaging surface of the observation device 50 is defined as b, and an energy intensity value at the certain coordinate position (x, y) in the output data of the observation device 50 is defined as E, a corrected energy intensity value E′ at the certain coordinate position (x, y) of the observation device 50 can be E′=(a/b). E. In this manner, the energy intensity distribution of the laser beam measured by the observation device 50, which is a distribution biased in the Y-axis direction, was corrected to an energy intensity distribution similar to the energy intensity distribution of the laser beam incident on the attenuation mechanism 40 using the calculation device 51.

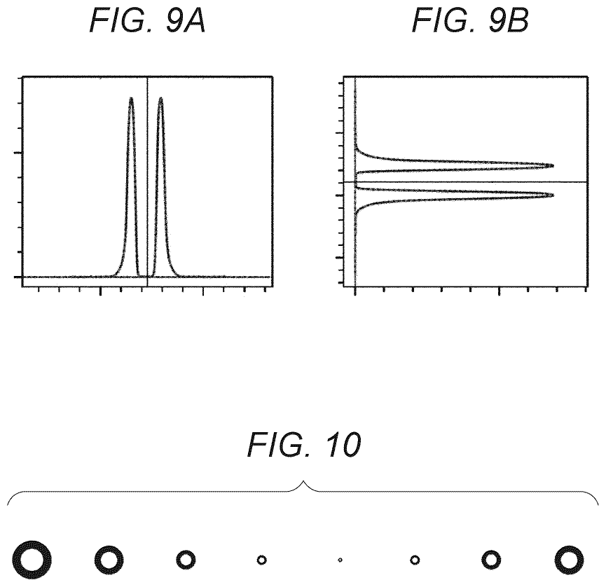

A result of an energy intensity distribution of the image at the spot corrected as described above is illustrated in FIGS. 9A and 9B. FIG. 9A illustrates an energy intensity distribution on the X axis of the image at the spot, with the horizontal axis representing a coordinate position on the X axis, and the vertical axis representing an energy intensity. FIG. 9B illustrates an energy intensity distribution on the Y axis of the image at the spot, with the vertical axis representing a coordinate position on the Y axis, and the horizontal axis representing an energy intensity. From FIGS. 9A and 9B, it was confirmed that the output data obtained from the laser beam measurement device in Example 1 was corrected so that the energy intensity distribution was not biased.

Next, a result of an image shape at the spot is illustrated in FIG. 10. As for a position in the horizontal direction, the left side of the drawing indicates a focus position corresponding to underfocus, and the right side of the drawing indicates a focus position corresponding to overfocus. From FIG. 10, it was confirmed that the image shape at the spot was circular and the image shape was corrected.

### Example 2

In Example 2, the configuration of the laser beam measurement device according to the second embodiment illustrated in FIG. 4, which was the second embodiment of the laser beam measurement device, was used. Then, the condenser lens 22 having an annular shape conversion function was used so that the image shape at the spot was annular. As the plate-type first beam splitter 42, a beam splitter having a thickness of 3 mm and a reflectance characteristic illustrated in FIG. 5 was used. Then, the first beam splitter 42 was disposed to be inclined by 45 degrees with the X axis as a rotation axis. In the second embodiment of the laser beam measurement device, in data output from the observation device 50, an energy intensity distribution is biased in the Y-axis direction. This was corrected by the following method.

The measured energy intensity distribution of the output data of the laser beam biased in the Y-axis direction of was corrected as follows. First, at each data position on the imaging surface of the spot position observation device 50, data on the incident angle on the first beam splitter 42 was acquired in advance by tracing an optical path of the light beam toward an emission point of the laser beam from the optical fiber 30 using a ray tracing method. As a result, an incident angle of the data output from the observation device 50 on the first beam splitter 42 can be specified from the data position on the imaging surface of the observation device 50. Here, a coordinate value on the X axis and a coordinate value on the Y axis of data output from the observation device 50 at a certain position are defined as x and y, respectively. Then, when a reflectance at the incident angle on the first beam splitter 42 at the position of the optical axis 10 is defined as i, a reflectance at the incident angle on the first beam splitter 42 of a laser beam reaching the certain coordinate position (x, y) on the imaging surface of the observation device 50 is defined as j, and an energy intensity value at the certain coordinate position (x, y) in the output data of the observation device 50 is defined as E, a corrected energy intensity value E′ at the certain coordinate position (x, y) of the observation device 50 can be E′=(i/j)·E. In this manner, the energy intensity distribution of the laser beam measured by the observation device 50, which is a distribution biased in the Y-axis direction, was corrected to an energy intensity distribution similar to the energy intensity distribution of the laser beam incident on the attenuation mechanism 40 using the calculation device 51.

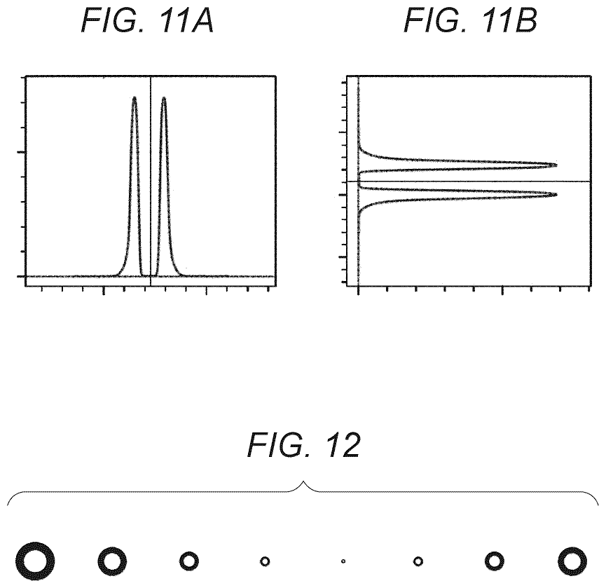

A result of an energy intensity distribution of the image at the spot corrected as described above is illustrated in FIGS. 11A and 11B. FIG. 11A illustrates an energy intensity distribution on the X axis of the image at the spot, with the horizontal axis representing a coordinate position on the X axis, and the vertical axis representing an energy intensity. FIG. 11B illustrates an energy intensity distribution on the Y axis of the image at the spot, with the vertical axis representing a coordinate position on the Y axis, and the horizontal axis representing an energy intensity. From FIGS. 11A and 11B, it was confirmed that the output data obtained from the laser beam measurement device in Example 2 was corrected so that the energy intensity distribution was not biased.

Next, a result of an image shape at the spot is illustrated in FIG. 12. As for a position in the horizontal direction, the left side of the drawing indicates a focus position corresponding to underfocus, and the right side of the drawing indicates a focus position corresponding to overfocus. From FIG. 12, it was confirmed that the image shape at the spot was circular. This is because, in Example 2, since light reflected by the first beam splitter 42 is used and astigmatism does not occur in the reflected light, an image shape similar to the image shape of the laser beam incident on the attenuation mechanism 40 can be obtained without correcting the output data.

### Example 3

In Example 3, the configuration of the laser beam measurement device according to the third embodiment illustrated in FIG. 7, which was the third embodiment of the laser beam measurement device, was used. Then, the condenser lens 22 having an annular shape conversion function was used so that the image shape at the spot was annular. As the plate-type first and second beam splitter 41 and 43, beam splitters each having a thickness of 3 mm and a transmittance characteristic illustrated in FIG. 2 were used. In addition, the first beam splitter 41 was disposed to be inclined by 45 degrees with the X axis as a rotation axis, and the second beam splitter 43 was disposed to be inclined by −45 degrees with the X′ axis as a rotation axis. In the third embodiment of the laser beam measurement device, in data output from the observation device 50, an image shape is biased in the Y-axis direction. This was corrected by the following method.

In the measured image shape of the output data of the laser beam distorted in the Y-axis direction, since the outer peripheral contour of the image shape of the laser beam incident on the attenuation mechanism 40 on the plane perpendicular to the optical axis 10 is a circle, a ratio of the size in the X-axis direction to the size in the Y-axis direction in the outer peripheral contour of the image shape of the laser beam incident on the attenuation mechanism 40 is 1:1. At this time, the image on the X axis of the image shape at the spot of the laser beam output from the attenuation mechanism 40 is not distorted. In addition, on the imaging surface of the observation device 50, a diameter value of an image in the X-axis direction is defined as c, a diameter value of an image in the Y-axis direction is defined as d, and a coordinate value on the X axis and a coordinate value on the Y axis of data output from the observation device 50 at a certain position is defined as x and y, respectively. At this time, a corrected data position of the certain position can be corrected to x for a coordinate value on the X axis and (c/d)·y for a coordinate value on the Y axis. In this manner, the image shape distorted in the Y-axis direction measured by the observation device 50 was corrected to an image shape similar to the image shape of the laser beam incident on the attenuation mechanism 40 using the calculation device 51.

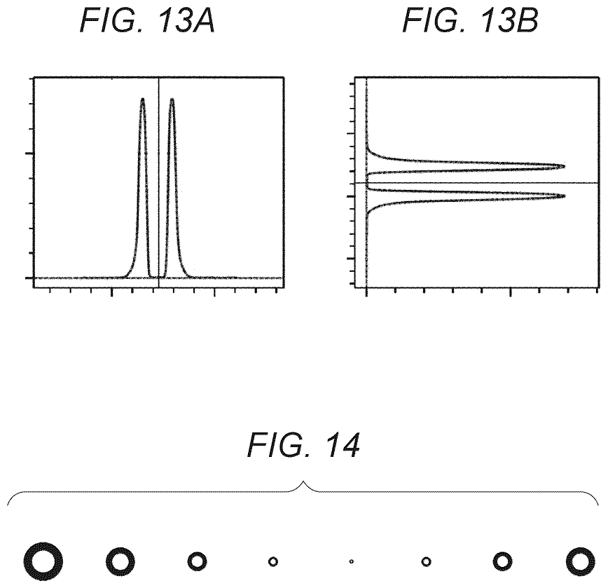

A result of an energy intensity distribution of the image at the spot corrected as described above is illustrated in FIGS. 13A and 13B. FIG. 13A illustrates an energy intensity distribution on the X axis of the image at the spot, with the horizontal axis representing a coordinate position on the X axis, and the vertical axis representing an energy intensity. FIG. 13B illustrates an energy intensity distribution on the Y axis of the image at the spot, with the vertical axis representing a coordinate position on the Y axis, and the horizontal axis representing an energy intensity. From FIGS. 13A and 13B, it was confirmed that the energy intensity distribution was not biased. This is because, in Example 3, since the attenuation mechanism 40 of the laser beam measurement device according to the third embodiment is used, an energy intensity distribution similar to the energy intensity distribution of the laser beam incident on the attenuation mechanism 40 can be obtained without correcting the output data.

Next, a result of an image shape at the spot is illustrated in FIG. 14. As for a position in the horizontal direction, the left side of the drawing indicates a focus position corresponding to underfocus, and the right side of the drawing indicates a focus position corresponding to overfocus. From FIG. 14, it was confirmed that the image shape at the spot was circular and the image shape was corrected.

### COMPARATIVE EXAMPLE

### Comparative Example 1

In Comparative Example 1, a configuration in which the calculation device 51 was removed from the laser beam measurement device according to the first embodiment illustrated in FIG. 1 was used. Then, the condenser lens 22 having an annular shape conversion function was used so that the image shape at the spot was annular. As the plate-type first beam splitter 41, a beam splitter having a thickness of 3 mm and a transmittance characteristic illustrated in FIG. 2 was used. Then, the first beam splitter 41 was disposed to be inclined by 45 degrees with the X axis as a rotation axis. In addition, the data output from the observation device 50 is not corrected.

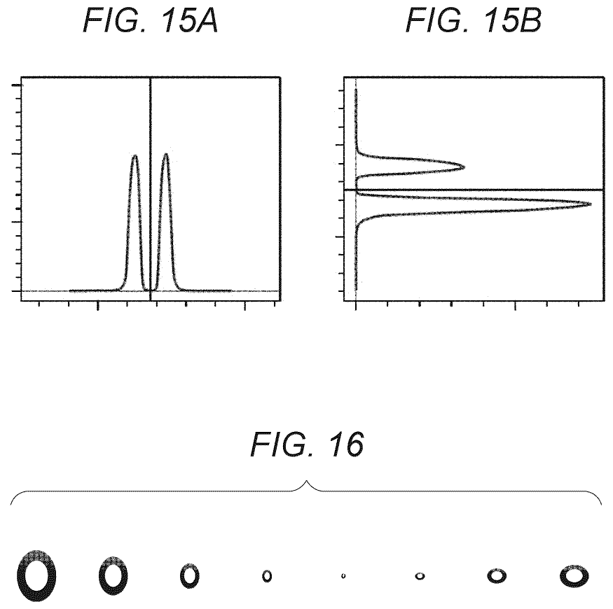

A result of an energy intensity distribution of the image at the spot is illustrated in FIGS. 15A and 15B. FIG. 15A illustrates an energy intensity distribution on the X axis of the image at the spot, with the horizontal axis representing a coordinate position on the X axis, and the vertical axis representing an energy intensity. FIG. 15B illustrates an energy intensity distribution on the Y axis of the image at the spot, with the vertical axis representing a coordinate position on the Y axis, and the horizontal axis representing an energy intensity. From FIGS. 15A and 15B, it was confirmed that the energy intensity distribution was biased for the output data obtained from the laser beam measurement device in Comparative Example 1.

Next, a result of an image shape at the spot is illustrated in FIG. 16. As for a position in the horizontal direction, the left side of the drawing indicates a focus position corresponding to underfocus, and the right side of the drawing indicates a focus position corresponding to overfocus. From FIG. 16, it was confirmed that the image shape at the spot was elliptical and the image shape was distorted in the Y-axis direction.

### Comparative Example 2

In Comparative Example 2, a configuration in which the calculation device 51 was removed from the laser beam measurement device according to the second embodiment illustrated in FIG. 4 was used. Then, the condenser lens 22 having an annular shape conversion function was used so that the image shape at the spot was annular. As the plate-type first beam splitter 42, a beam splitter having a thickness of 3 mm and a reflectance characteristic illustrated in FIG. 5 was used. Then, the first beam splitter 42 was disposed to be inclined by 45 degrees with the X axis as a rotation axis. In addition, the data output from the observation device 50 is not corrected.

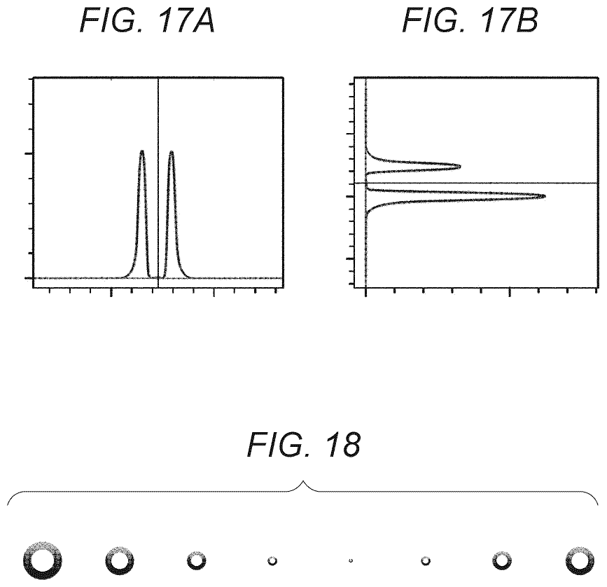

A result of an energy intensity distribution of the image at the spot is illustrated in FIGS. 17A and 17B. FIG. 17A illustrates an energy intensity distribution on the X axis of the image at the spot, with the horizontal axis representing a coordinate position on the X axis, and the vertical axis representing an energy intensity. FIG. 17B illustrates an energy intensity distribution on the Y axis of the image at the spot, with the vertical axis representing a coordinate position on the Y axis, and the horizontal axis representing an energy intensity. From FIGS. 17A and 17B, it was confirmed that the energy intensity distribution was biased for the output data obtained from the laser beam measurement device in Comparative Example 2.

Next, a result of an image shape at the spot is illustrated in FIG. 18. As for a position in the horizontal direction, the left side of the drawing indicates a focus position corresponding to underfocus, and the right side of the drawing indicates a focus position corresponding to overfocus. From FIG. 18, it was confirmed that the image shape at the spot was circular and the image shape was not distorted.

### Comparative Example 3

In Comparative Example 3, a configuration in which the calculation device 51 was removed from the laser beam measurement device according to the third embodiment illustrated in FIG. 7 was used. Then, the condenser lens 22 having an annular shape conversion function was used so that the image shape at the spot was annular. As the plate-type first and second beam splitter 41 and 43, beam splitters each having a thickness of 3 mm and a transmittance characteristic illustrated in FIG. 2 were used. In addition, the first beam splitter 41 was disposed to be inclined by 45 degrees with the X axis as a rotation axis, and the second beam splitter 43 was disposed to be inclined by −45 degrees with the X′ axis as a rotation axis. In addition, the data output from the observation device 50 is not corrected.

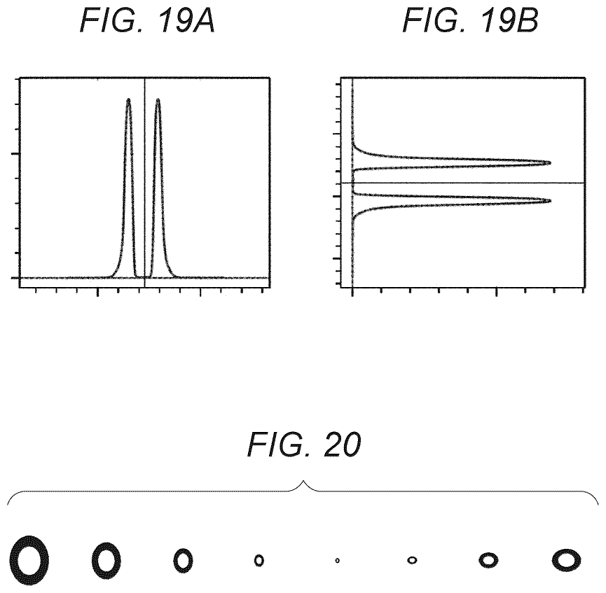

A result of an energy intensity distribution of the image at the spot is illustrated in FIGS. 19A and 19B. FIG. 19A illustrates an energy intensity distribution on the X axis of the image at the spot, with the horizontal axis representing a coordinate position on the X axis, and the vertical axis representing an energy intensity. FIG. 19B illustrates an energy intensity distribution on the Y axis of the image at the spot, with the vertical axis representing a coordinate position on the Y axis, and the horizontal axis representing an energy intensity. From FIGS. 19A and 19B, it was confirmed that the energy intensity distribution was not biased for the output data obtained from the laser beam measurement device in Comparative Example 1.

Next, a result of an image shape at the spot is illustrated in FIG. 20. As for a position in the horizontal direction, the left side of the drawing indicates a focus position corresponding to underfocus, and the right side of the drawing indicates a focus position corresponding to overfocus. From FIG. 20, it was confirmed that the image shape at the spot was elliptical and the image shape was distorted in the Y-axis direction.

The laser beam measurement device according to the present invention is capable of measuring an image shape and an energy intensity distribution of the laser beam at the spot, by attenuating the laser beam to such an extent that a device for acquiring image data such as an image sensor or a camera is not destroyed, even if the energy intensity of the laser beam is high. In addition, even if light is focused at an incident angle that varies depending on the incident position, the laser beam measurement device according to the present invention can correct an energy intensity and a coordinate position in data output from the observation device, resulting in an accurate measurement. That is, the laser beam measurement device according to the present invention is suitable for measuring an image shape and an energy intensity distribution of a laser beam at a spot in a laser processing device that irradiates an object to be processed with the laser beam.

What is claimed is:

1. A laser beam measurement device for a laser beam emitted from a laser beam irradiation optical unit configured to form a spot while emitting the laser beam to an object to be processed for laser processing, the laser beam measurement device comprising:
a plate-type first beam splitter; an observation device configured to read an image of the spot formed by transmitted light or reflected light of the laser beam incident on the first beam splitter; and a calculation device configured to perform a numerical calculation on output data of the observation device to perform a correction,
wherein when certain coordinate axes orthogonal to each other on a plane perpendicular to an optical axis of the laser beam irradiation optical unit with origins of the orthogonal coordinate axes being located on the optical axis are defined as X and Y axes, the first beam splitter is disposed to be inclined at an angle α in a range of 30 degrees or more and 60 degrees or less with respect to the plane perpendicular to the optical axis with the X axis as a rotation axis.

2. The laser beam measurement device according to claim 1, further comprising a plate-type second beam splitter, wherein the second beam splitter is disposed to be inclined at an angle −α with respect to the plane perpendicular to the optical axis with an X′ axis as a rotation axis, the X′ axis being parallel to the X axis and passing through the optical axis, and the spot is formed by transmitted light of the laser beam incident on the first beam splitter and the second beam splitter.

3. The laser beam measurement device according to claim 1, wherein when an incident angle of the laser beam is 45 degrees, the first beam splitter has a transmittance of 0.1% or more and 5.0% or less, or a reflectance of 0.1% or more and 5.0% or less.

4. The laser beam measurement device according to claim 2, wherein when an incident angle of the laser beam is 45 degrees, the first beam splitter and the second beam splitter have a transmittance of 0.1% or more and 5.0% or less.

5. The laser beam measurement device according to claim 1, wherein in a case where the image of the spot is formed by the transmitted light, the calculation device has a numerical calculation function for:
correcting an energy intensity in the output data in a Y-axis direction of the output data based on a transmittance value of the first beam splitter corresponding to an incident angle of the laser beam on the first beam splitter; and
correcting a coordinate position in the output data by correcting the coordinate position in the Y-axis direction of the output data based on a ratio value between a largest value of a size of the image in an X-axis direction and a largest value of a size of the image in the Y-axis direction in an image shape on the observation device.

6. The laser beam measurement device according to claim 1, wherein in a case where the image of the spot is formed by the reflected light, the calculation device has a numerical calculation function for:
correcting an energy intensity in the output data in a Y-axis direction of the output data based on a reflectance value of the first beam splitter corresponding to an incident angle of the laser beam on the first beam splitter.

7. The laser beam measurement device according to claim 2, wherein the calculation device has a numerical calculation function for:
correcting a coordinate position in the output data by correcting the coordinate position in a Y-axis direction of the output data based on a ratio value between a largest value of a size of the image in an X-axis direction and a largest value of a size of the image in the Y-axis direction in an image shape on the observation device.

8. An output data correction method of the calculation device in the laser beam measurement device according to claim 1, the calculation device performing a correction by performing a numerical calculation on output data of an observation device that reads an image of a spot formed by transmitted light of a laser beam incident on a first beam splitter, the output data correction method comprising:
performing a numerical calculation for correcting an energy intensity in the output data in a Y-axis direction of the output data based on a transmittance value of the first beam splitter corresponding to an incident angle of the laser beam on the first beam splitter; and
performing a numerical calculation for correcting a coordinate position in the output data by correcting the coordinate position in a Y-axis direction of the output data based on a ratio value between a largest value of a size of the image in an X-axis direction and a largest value of a size of the image in the Y-axis direction in an image shape on the observation device.

9. An output data correction method of the calculation device in the laser beam measurement device according to claim 1, the calculation device performing a correction by performing a numerical calculation on output data of the observation device that reads an image of a spot formed by reflected light of a laser beam incident on the first beam splitter, the output data correction method comprising:
performing a numerical calculation for correcting an energy intensity in the output data in a Y-axis direction of the output data based on a reflectance value of the first beam splitter corresponding to an incident angle of the laser beam on the first beam splitter.

10. An output data correction method of the calculation device in the laser beam measurement device according to claim 2, the calculation device performing a correction by performing a numerical calculation on output data of the observation device that reads an image of a spot formed by transmitted light of a laser beam incident on the first beam splitter and the second beam splitter, the output data correction method comprising:
performing a numerical calculation for correcting a coordinate position in the output data by correcting the coordinate position in a Y-axis direction of the output data based on a ratio value between a largest value of a size of the image in an X-axis direction and a largest value of a size of the image in the Y-axis direction in an image shape on the observation device.
